(19) United States
(12) Patent Application Publication
(10) Pub. No.: US 2019/0289139 A1
(43) Pub. Date: Sep. 19, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/055,167

(22) Filed: Aug. 6, 2018

(30) Foreign Application Priority Data
Mar. 15, 2018 (JP) 2018-047439

(51) Int. Cl. H04N 1/00

(52) U.S. Cl. CPC H04N 1/00037; H04N 2201/0094; H04N 1/00938; H04N 1/00082

(57) ABSTRACT

An information processing apparatus includes a controller. If a role is associated with an image that is associated with a configuration to be used for a collaborative function, the controller changes, in accordance with the role, the collaborative function to be set by using the image.

### CROSS-REFERENCE TO RELATED APPLICATIONS

This application is based on and claims priority under 35 USC 119 from Japanese Patent Application No. 2018-047439 filed Mar. 15, 2018.

### BACKGROUND

### (i) Technical Field

The present invention relates to an information processing apparatus and a non-transitory computer readable medium.

### (ii) Related Art

A collaborative function that is executable by using a device, software, and the like may be set in some cases.

### SUMMARY

According to an aspect of the invention, there is provided an information processing apparatus including a controller. If a role is associated with an image that is associated with a configuration to be used for a collaborative function, the controller changes, in accordance with the role, the collaborative function to be set by using the image.

### BRIEF DESCRIPTION OF THE DRAWINGS

Exemplary embodiments of the present invention will be described in detail based on the following figures, wherein:

FIG. 1 is a block diagram of the configuration of an information processing system according to an exemplary embodiment of the present invention;

FIG. 2 is a block diagram of the configuration of a terminal apparatus;

FIG. 3 illustrates a screen;

FIG. 4 illustrates a configuration management table;

FIG. 5 illustrates the screen;

FIG. 6 illustrates a candidate management table;

FIG. 7 illustrates the screen;

FIG. 8 illustrates the screen;

FIG. 9 illustrates the screen;

FIG. 10 illustrates the screen;

FIG. 11 illustrates a configuration image;

FIG. 12 illustrates the configuration image;

FIG. 13 illustrates a device;

FIG. 14 illustrates the screen;

FIG. 15 illustrates a compatibility management table;

FIG. 16 illustrates the screen;

FIG. 17 illustrates the screen;

FIG. 18 illustrates the screen;

FIG. 19 illustrates the screen;

FIG. 20 illustrates the screen;

FIG. 21 illustrates the screen; and

FIG. 22 illustrates a function management table.

### DETAILED DESCRIPTION

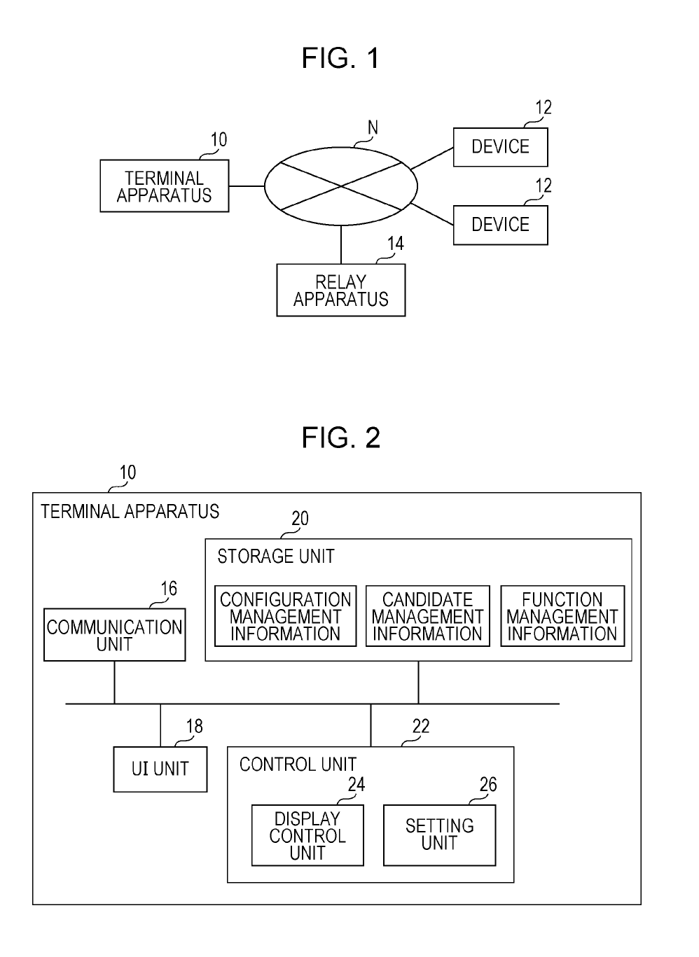

Now, an information processing system according to an exemplary embodiment of the present invention will be described with reference to FIG. 1. FIG. 1 illustrates an example of the information processing system according to this exemplary embodiment.

The information processing system according to this exemplary embodiment includes, as an example, one or more terminal apparatuses 10, one or more devices 12, and one or more relay apparatuses 14. In the example illustrated in FIG. 1, the information processing system includes one terminal apparatus 10, two devices 12, and one relay apparatus 14. These numbers are merely examples, and other numbers of terminal apparatuses, devices, or relay apparatuses may be included in the information processing system. The terminal apparatus 10, the devices 12, and the relay apparatus 14 have, as an example, a function of communicating with each other via a communication path N such as a network. The communication may be wireless communication or wired communication. As the communication path N, the Internet may be used. It is needless to say that the terminal apparatus 10, the devices 12, and the relay apparatus 14 may communicate with another apparatus via a different communication path, or may directly communicate with another apparatus, without using the communication path N. In addition, the relay apparatus 14 may serve as a hub that connects multiple apparatuses to each other. In this case, the terminal apparatus 10 and the devices 12 may be connected to the relay apparatus 14 to communicate with each other via the relay apparatus 14. An apparatus such as a server may be included in the information processing system.

Note that, if the relay apparatus 14 is not used, the relay apparatus 14 may be omitted from the information processing system. Similarly, if the devices 12 are not used, the devices 12 may be omitted from the information processing system. As will be described later, a collaborative function that is executable by using the devices 12, software, or the like is set. If the devices 12 are not used for the collaborative function, the devices 12 may be omitted from the information processing system. The collaborative function will be described later in detail.

The terminal apparatus 10 as an information processing apparatus is an apparatus such as a personal computer (PC), a tablet PC, a smartphone, or a mobile phone, and has a function of communicating with another apparatus. The terminal apparatus 10 may be a wearable terminal (e.g., wristwatch-type terminal, wristband-type terminal, glasses-type terminal, ring-type terminal, contact-lens-type terminal, in-body-embedded type terminal, or in-ear wearable terminal). In addition, the terminal apparatus 10 may include a flexible display as a display apparatus. Examples of the flexible display include an organic electroluminescent display (flexible organic EL display), a display in the form of electronic paper, a flexible liquid crystal display, and the like. Any flexible display using another display method may be used. In the flexible display, the display part may be flexibly deformed and may be, for example, bent, folded, wound, twisted, or stretched. The entire terminal apparatus 10 may be formed as the flexible display, or the flexible display and other configurations may be functionally or physically independent of each other.

Each of the devices 12 is an apparatus having functions and is, for example, an image forming apparatus having an image forming function (e.g., a scan function, a print function, a copy function, or a facsimile function), a PC, a tablet PC, a smart phone, a mobile phone, a robot (a humanoid robot, an animal-shaped robot other than the humanoid robot, or any other type of robot), a projector, a display apparatus such as a liquid crystal display, a recording apparatus, a reproducing apparatus, an image capturing apparatus such as a camera, a refrigerator, a rice cooker, a microwave oven, a coffee maker, a vacuum cleaner, a washing machine, an air conditioner, a lighting apparatus, a timepiece, a security surveillance camera, a motor vehicle, a two-wheeled vehicle, an aircraft (e.g., unmanned aerial vehicle (so-called drone), a game console, any of various sensing devices (e.g., a temperature sensor, a humidity sensor, a voltage sensor, or an electric current sensor), or the like. Each of the devices 12 may provide information to a user (e.g., an image forming apparatus or a PC) or does not have to provide information to a user (e.g., a sensing device). In addition, all of the multiple devices that execute the collaborative function, which will be described later, may provide information to a user; some of the devices may provide information to a user while the others do not provide information to a user; or none of the devices may provide information to a user. The concept of a device 12 may encompass every type of device. For example, the device according to this exemplary embodiment may encompass an information device, a movie device, an audio device, and other devices. In addition, the device 12 has a function of communicating with another apparatus.

The relay apparatus 14 controls the operations of the devices 12. In addition, the relay apparatus 14 has a function of communicating with another apparatus. The relay apparatus 14 may acquire various pieces of information by using, for example, the Internet or the like. The relay apparatus 14 may serve as a server or may manage data or user information, for example. The relay apparatus 14 may be a so-called smart speaker (device having a wireless communication function and a speaker function) or may be a device that has a communication function but does not have a speaker function. The relay apparatus 14 may be installed indoors (e.g., on the floor, the ceiling, or a table in a room) or outdoors. In addition, the relay apparatus 14 may be a movable device (e.g., a self-running device). Note that one of the devices 12 may serve as the relay apparatus 14.

The terminal apparatus 10 may control the operations of the devices 12 by communicating with the devices 12 directly or via another device or a communication path without using the relay apparatus 14 therebetween.

In this exemplary embodiment, as an example, the collaborative function is set by using the terminal apparatus 10. The collaborative function is a function that is executable by using one or more configurations. For example, the collaborative function is executable by causing multiple configurations to work in collaboration with each other. The configurations are, for example, the devices 12 as hardware or are software. The collaborative function may be executable by using multiple functions of a single device or a single piece of software.

The terminal apparatus 10 or the relay apparatus 14 may be used as a device that executes the collaborative function, or a function of the terminal apparatus 10 or the relay apparatus 14 may be used for the collaborative function. The software that is used for the collaborative function may be stored in the terminal apparatus 10 or may be stored in the devices 12, the relay apparatus 14, or another apparatus (e.g., a server).

The entire devices 12, a specific part of the devices 12, a specific function of software, a set of functions including multiple functions, and the like may be used as the configurations. For example, if a function is assigned to each part of the devices 12, the collaborative function may be a function that uses the part. In addition, if software has multiple functions, the collaborative function may be a function that uses some of the multiple functions. The set of functions is configured from multiple functions, and a process using the set of functions is executed by simultaneously or sequentially executing the multiple functions. Furthermore, the collaborative function may use only hardware, only software, or both hardware and software.

The collaborative function may be a function that is executable by causing multiple configurations that differ from each other to work in collaboration with each other, or may be a function that is executable by causing the same configurations to work in collaboration with each other. The collaborative function may be a function that is not usable before collaboration. For example, by causing a device having a print function (printer) and a device having a scan function (scanner) to work in collaboration with each other, a copy function as the collaborative function becomes executable. That is, by causing the print function and the scan function to work in collaboration with each other, the copy function becomes executable.

The concept of the collaborative function may encompass a composite function that enables execution of a new function by causing the multiple devices 12 or multiple pieces of software to work in collaboration with each other. For example, by combining multiple displays, an expansion display function as the composite function may be realized. As another example, by combining a television set and a recorder, a recording function as the composite function may be realized. The recording function may be a function of recording an image displayed on the television set. In addition, by combining multiple cameras, an imaging field expanding function as the composite function may be realized. This expanding function is an imaging function by connecting, for example, imaging fields of cameras to each other. In addition, by combining a telephone and a translation machine or translation software, a translated-conversation function (function of translating conversations on the telephone) as the composite function may be realized. In the above manner, the concept of the collaborative function may encompass a function that becomes executable by causing the multiple devices 12 or multiple pieces of software of the same type to work in collaboration with each other, and a function that becomes executable by causing the multiple devices 12 or multiple pieces of software of different types to work in collaboration with each other.

More specifically, the collaborative function is a function that is executable by using a configuration with which a role is associated. Examples of the role include an input process and an output process. Hereinafter, a configuration with which the input process as the role is associated will be referred to as an “input configuration”, and a configuration with which the output process as the role is associated will be referred to as an “output configuration”. An example of the collaborative function is executed by causing the input configuration and the output configuration to work in collaboration with each other.

The input configuration is a configuration for inputting (transmitting) data to another configuration (device 12 or software). Note that the transmission has the same meaning as an input in the following description. The other configuration may be another input configuration or the output configuration. The concept of the input process encompasses a process for only inputting data, a process including pre-processing of data and inputting of data, and the like. That is, the input configuration may execute pre-processing and may input the result of the pre-processing to another configuration or may input data to another configuration without executing the pre-processing. The concept of the pre-processing encompasses, for example, a data generating process, a data collecting process, a data collating process, and the like. The concept of the data generating process encompasses a process for extracting data from data (extracting process), a process for processing data (processing process), a process for generating new data by combining multiple data items (combining process), a process for generating new data by synthesizing multiple data items (synthesizing process), and the like. One or more data items that have been input from one or more configurations may be subjected to the above generating process, or one or more data items that have been generated by one or more configurations may be subjected to the above generating process. For example, if the input process including the combining process is associated with multiple configurations, multiple data items from the multiple configurations may be combined. The concept of the data collecting process encompasses measurement, detection, and the like of data. The data collating process is, for example, a process for collating multiple data items that have been input from one or more configurations or multiple data items that have been generated by one or more configurations. For example, if the input process including the collating process is associated with multiple configurations, multiple data items from the multiple configurations may be collated. The input configuration may apply the input process to data that has been input thereto from another input configuration or may execute the input process in response to the input of data thereto from the other input configuration, without using the data. The input configuration may input the data that has been input thereto from another input configuration to still another configuration as the input process. As another example, the input configuration may execute a process that is associated with the input configuration as the input process and may input the data that is generated through the process to another configuration. As still another example, the input configuration may collect data and may input the collected data to another configuration as the input process.

The output configuration is a configuration for executing the output process. The output process may be a process including the above pre-processing (e.g., a data generating process, a data collecting process, or a data collating process). The output configuration may execute the output process by using data that has been input (transmitted) from the input configuration to the output configuration. As another example, the output configuration may execute the output process in response to the input of data from the input configuration to the output configuration, without using the data. The output configuration may execute the output process by using data other than the data that has been input to the output configuration. The output process corresponds to a final process included in the collaborative function.

Note that the collaborative function is set by using the terminal apparatus 10 in this exemplary embodiment, the collaborative function may be set by using the devices 12 or the relay apparatus 14.

Now, the configuration of the terminal apparatus 10 will be described in detail with reference to FIG. 2.

A communication unit 16 is a communication interface and has a function of transmitting data to another apparatus and a function of receiving data from another apparatus. The communication unit 16 may be a communication interface having a wireless communication function or may be a communication interface having a wired communication function. The communication unit 16 corresponds to, for example, one or more types of communication schemes, and may communicate with a communication partner in accordance with a communication scheme that is suitable for the communication partner (i.e., a communication scheme compliant with the communication partner). Examples of the communication scheme include infrared communication, visible light communication, Wi-Fi (registered trademark) communication, short-range wireless communication (e.g., Near Field Communication (NFC)), and the like. For short-range wireless communication, Felica (registered trademark), Bluetooth (registered trademark), Radio Frequency Identifier (RFID), or the like is used. It is needless to say that wireless communication of another scheme may also be used for short-range wireless communication. The communication unit 16 may switch the communication scheme or frequency band in accordance with the communication partner or may switch the communication scheme or frequency band in accordance with the ambient environment.

A user interface (UI) unit 18 is a user interface and includes a display unit and an operation unit. The display unit is a display apparatus such as a liquid crystal display. The display unit may be a flexible display. The operation unit is an input apparatus such as a touch panel or a keyboard. A user interface that serves as the display unit and the operation unit (e.g., a touch display or an apparatus that displays an electronic keyboard or the like on a display) may be used. In addition, the UI unit 18 may further include a sound collecting unit such as a microphone or an audio generating unit such as a speaker. In this case, information may be input to the terminal apparatus 10 by audio input, and information may be output by using audio.

A storage unit 20 is a storage apparatus such as a hard disk or a memory (e.g., a solid state drive (SSD)). The storage unit 20 stores, for example, configuration management information, candidate management information, function management information, various data items, various programs (e.g., an operating system (OS) and various application programs (application software)), information indicating the addresses of the devices 12 (device address information), information indicating the address of the relay apparatus 14 (relay-apparatus address information), and the like. The data items, information items, programs, and the like may be stored in different storage apparatuses or may be stored in a single storage apparatus.

The configuration management information is information used for managing a configuration with which a role is associated. For example, in the configuration management information, the following information items are associated with each other for each configuration: configuration identification information for identifying the configuration, role information indicating the role that is associated with the configuration, information indicating a process to be executed by the configuration in accordance with the role, information indicating a condition under which the process is executed, and connection information indicating a connection relationship between configurations. The information indicating a process includes information indicating the details of data to be input (transmitted) to another configuration. The connection information is information indicating another configuration that is connected to the configuration. As will be described later, an input process or an output process is associated with the configuration by a setting unit 26, and the information indicating the association is registered in the configuration management information.

The candidate management information is information used for managing candidate processes to be executed by the configuration in accordance with the role. For example, the configuration management information includes, for each configuration, information indicating the candidate processes to be executed by the configuration in accordance with the role and information indicating candidate conditions for executing the processes, which are associated with each other. The information indicating the candidate processes includes information indicating the details of candidate data to be input (transmitted) to another configuration. The configuration management information is, for example, created in advance and is stored in the storage unit 20.

The function management information is information used for managing the collaborative function that has been set. For example, the function management information includes, for each collaborative function, the combination of the configuration identification information for identifying configurations to be used for the collaborative function and function information regarding the collaborative function, which are associated with each other. The above role is associated with the configurations to be used for the collaborative function.

Examples of the configuration identification information include the name of the configuration, a symbol, an image associated with the configuration, and the like. Examples of the function information include identification information such as the name or ID of the collaborative function and details information indicating the details of the collaborative function. Hereinafter, an image associated with a configuration will be referred to as a “configuration image”.

If the configuration is a device 12, the configuration identification information is information for identifying the device 12 (device identification information). If the configuration is software, the configuration identification information is information for identifying the software (software identification information). The configuration identification information for identifying the device 12 may include information indicating a function of the device 12. Similarly, the configuration identification information for identifying the software may include information indicating a function of the software.

Examples of the device identification information include the name of the device 12, the device ID, information indicating the type of the device 12, the model number of the device 12, information for managing the device 12 (e.g., property management information), information indicating the position where the device 12 is installed (device position information), an image associated with the device 12 (device image), device address information, and the like. The device image is, for example, an external appearance image of the device 12. The external appearance image may be an image representing the external side of the device 12 (e.g., a housing of the device), an image representing a state in which the housing is open and the inside may be seen from outside (e.g., an internal structure), or an image representing a state in which the device 12 is covered with a wrapping sheet or the like. The device image may be an image generated by imaging the device 12 by an imaging apparatus such as a camera (e.g., an image representing the external appearance of the device 12 or an image representing the inside thereof), or may be an image schematically representing the device 12 (e.g., an icon). The device image may be a still image or a moving image. The data of the device image may be stored in the storage unit 20 or may be stored in another apparatus (e.g., the device 12, the relay apparatus 14, or a server).

Examples of the software identification information include the name of the software, the software ID, information indicating the type of the software, the model number of the software, information for managing the software, an image associated with the software (software image), and the like. The software image is, for example, an image representing the software (e.g., an icon). The software image may be a still image or a moving image. The data of the software image may be stored in the storage unit 20 or may be stored in another apparatus (e.g., the device 12, the relay apparatus 14, or a server).

Note that the configuration management information, the candidate management information, and the function management information may be stored in an apparatus other than the terminal apparatus 10 (e.g., the device 12, the relay apparatus 14, or a server). In this case, the configuration management information, the candidate management information, and the function management information do not have to be stored in the terminal apparatus 10.

A control unit 22 is configured to control the operation of each unit of the terminal apparatus 10. For example, the control unit 22 executes various programs, controls communication of the communication unit 16, controls notification of information (e.g., display of information or audio output) by using the UI unit 18, and receives information that has been input to the terminal apparatus 10 by using the UI unit 18. In addition, the control unit 22 includes a display control unit 24 and the setting unit 26.

The display control unit 24 is configured to cause the display unit to display various information items for setting the collaborative function. For example, the display control unit 24 sets (forms), on a screen of the display unit, a display region with which the input process or the output process as the role is associated, and causes a configuration image to be displayed in the display region. In addition, the display control unit 24 may cause the display unit to display various information items other than the information regarding the collaborative function.

The setting unit 26 is configured to set the collaborative function that is executable by using multiple configurations by associating the input process or the output process as the role with the configuration image. For example, if the configuration image is displayed in the display region with which with the role is associated, the setting unit 26 associates the role with the configuration that is associated with the configuration image. If the configuration image is displayed in the display region with which the input process is associated, the setting unit 26 associates the input process with the configuration that is associated with the configuration image, and registers the configuration as the input configuration in the configuration management information. Thus, the configuration is used as the input configuration. If the configuration image is displayed in the display region with which the output process is associated, the setting unit 26 associates the output process with the configuration that is associated with the configuration image, and registers the configuration as the output configuration in the configuration management information. Thus, the configuration is used as the output configuration. In addition, the setting unit 26 registers the connection information between the configurations in the configuration management information. The setting unit 26 sets the collaborative function that is executable by using the input configuration and the output configuration, and registers the combination of the input configuration, the output configuration, and the collaborative function in the function management information. If the role that is associated with the configuration image is changed, the setting unit 26 changes the collaborative function. That is, in accordance with the role that is associated with the configuration image, the setting unit 26 changes the collaborative function that is set by using the configuration image.

Note that the setting unit 26 may be provided in an apparatus other than the terminal apparatus 10 (e.g., the device 12, the relay apparatus 14, or a server), and the apparatus other than the terminal apparatus 10 may execute the processes by using the setting unit 26. In this case, the setting unit 26 does not have to be provided in the terminal apparatus 10.

### Outline of Collaborative-Function Setting Process

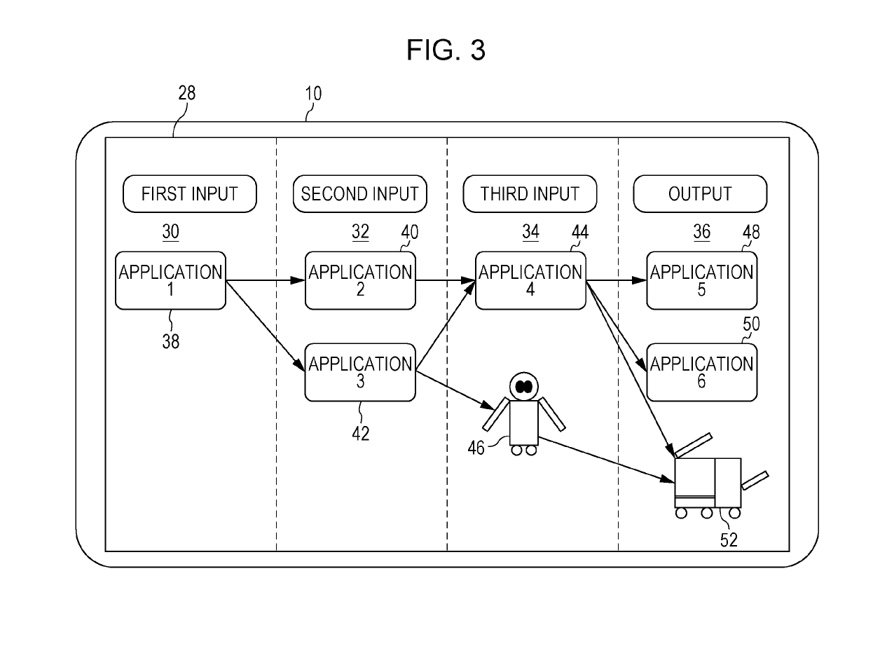

Now, a collaborative-function setting process will be described with reference to FIG. 3.

FIG. 3 illustrates an example of a screen for setting the collaborative function. For example, if software for setting the collaborative function is started, or if the terminal apparatus 10 accesses a Web site for setting the collaborative function, the display control unit 24 causes the display unit of the UI unit 18 to display a screen 28 for setting the collaborative function. Note that the software may be installed in the terminal apparatus 10 or may be installed in an apparatus other than the terminal apparatus 10.

The display control unit 24 sets (forms), on the screen 28, the display region with which the role is associated. Specifically, the display control unit 24 sets, on the screen 28, one or more input display regions and one or more output display regions. Each input display region is a display region with which the input process as the role is associated. Each output display region is a display region with which the output process as the role is associated.

In the example illustrated in FIG. 3, a first input display region 30, a second input display region 32, and a third input display region 34 are arranged in this order as the input display regions. In addition, next to the third input display region 34 (on the side opposite to the second input display region 32), an output display region 36 is arranged. Note that only a single input display region may be set, four or more input display regions may be set, and multiple output display regions may be set. In addition, a user may designate the number of input display regions and the number of output display regions. The display control unit 24 sets the input display regions and the output display regions, the numbers of which are designated by a user, on the screen 28.

If the configuration image is displayed in the first input display region 30, the second input display region 32, or the third input display region 34, the setting unit 26 associates the input process as the role with the configuration associated with the configuration image and the input condition for executing the input process, and registers the configuration as the input configuration in the configuration management information. Specifically, if the configuration image is displayed in the first input display region 30, the setting unit 26 associates a first input process and a first input condition with the configuration associated with the configuration image, and registers the configuration as a first input configuration in the configuration management information. Similarly, if the configuration image is displayed in the second input display region 32, the setting unit 26 associates a second input process and a second input condition with the configuration associated with the configuration image, and registers the configuration as a second input configuration in the configuration management information. Similarly, if the configuration image is displayed in the third input display region 34, the setting unit 26 associates a third input process and a third input condition with the configuration associated with the configuration image, and registers the configuration as a third input configuration in the configuration management information. Specific details of each input process are designated by a user.

In addition, if the configuration image is displayed in the output display region 36, the setting unit 26 associates an output process as the role and an output condition with the configuration associated with the configuration image for executing the output process, and registers the configuration as the output configuration in the configuration management information. Specific details of the output process are designated by a user.

The configurations are connected to each other by a user operation. That is, a data input destination (transmission destination) is designated by a user. For example, if a user performs an operation for joining the configuration images to each other, the data input destination is designated. Specifically, if a user performs an operation for joining the configuration image associated with the first input configuration and the configuration image associated with the second input configuration to each other, the setting unit 26 connects the first input configuration and the second input configuration to each other, and registers the connection information representing the connection relationship in the configuration management information in association with each of the first input configuration and the second input configuration. The connection information associated with the first input configuration includes the configuration identification information indicating the second input configuration as the connection partner. The connection information associated with the second input configuration includes the configuration identification information indicating the first input configuration as the connection partner. The same applies to the other configurations. By referring to the connection information, the connection relationship between configurations is identified.

During the execution of the collaborative function, if the first input condition associated with the first input configuration is satisfied, the first input configuration executes the first input process to input (transmit) data to the second input configuration and the following configurations. For example, if the second input configuration is connected to the first input configuration, the first input configuration inputs data to the second input configuration. If the second input condition associated with the second input configuration is satisfied, the second input configuration executes the second input process to input data to the third input configuration and the following configuration. For example, if the third input configuration is connected to the second input configuration, the second input configuration inputs data to the third input configuration. If the third input condition associated with the third input configuration is satisfied, the third input configuration executes the third input process to input data to the output configuration connected to the third input configuration. If the output condition associated with the output configuration is satisfied, the output configuration executes the output process. The data to be input (transmitted) is data generated through a process, data used for a process, data that is collected, or the like.

In the above manner, during the execution of the collaborative function, the data is transmitted from the first input configuration to the output configuration. If the first input configuration is connected to multiple input configurations including the second input configuration and the following input configuration, data is input (transmitted) from the first input configuration to the multiple input configurations. The same applies to the input configurations other than the first input configuration.

In addition, by a user connecting the configurations to each other, the configurations are designated as configurations for executing the collaborative function together, and the setting unit 26 registers each of the configurations as a configuration to be used for the collaborative function in the function management information.

Now, specific examples will be described. A software image 38 is displayed as an example of the configuration image by a user operation in the first input display region 30. The software image 38 is an image that is associated with an application 1 as software. The setting unit 26 associates the first input process and the first input condition with the application 1 and registers the application 1 as the first input configuration in the configuration management information. Thus, the application 1 is used as the first input configuration.

Software images 40 and 42 are displayed as examples of the configuration images by a user operation in the second input display region 32. The software image 40 is an image that is associated with an application 2 as software. The software image 42 is an image that is associated with an application 3 as software. The setting unit 26 associates the second input process and the second input condition with the application 2 and registers the application 2 as the second input configuration in the configuration management information. Similarly, the setting unit 26 associates the second input process and the second input condition with the application 3 and registers the application 3 as the second input configuration in the configuration management information. Thus, the applications 2 and 3 are each used as the second input configuration.

A software image 44 and a device image 46 are displayed as examples of the configuration images by a user operation in the third input display region 34. The software image 44 is an image that is associated with an application 4 as software. The device image 46 is an image that is associated with a robot B as a device 12. The setting unit 26 associates the third input process and the third input condition with the application 4 and registers the application 4 as the third input configuration in the configuration management information. Similarly, the setting unit 26 associates the third input process and the third input condition with the robot B and registers the robot B as the third input configuration in the configuration management information. Thus, the application 4 and the robot B are each used as the third input configuration.

Software images 48 and 50 and a device image 52 are displayed as examples of the configuration images by a user operation in the output display region 36. The software image 48 is an image that is associated with an application 5 as software. The software image 50 is an image that is associated with an application 6 as software. The device image 52 is an image that is associated with a multi-function device A as a device 12. The setting unit 26 associates the output process with each of the applications 5 and 6 and the multi-function device A and registers the applications 5 and 6 and the multi-function device A as the output devices in the configuration management information. Thus, the applications 5 and 6 and the multi-function device A are each used as the output configuration.

Each of the above software images and each of the device images are disposed in a corresponding display region by a user operation. Note that, as will be described later, the input process and the output process that are to be executed by each of the configurations are designated by a user.

In addition, by an operation for joining the configuration images to each other, the configurations are connected to each other, and the data input destination (transmission destination) is designated. In the example illustrated in FIG. 3, the configurations are joined by using arrows.

For example, if a user performs an operation for joining the software image 38 and the software image 40 to each other by using the UI unit 18, the display control unit 24 causes an image of an arrow to be displayed on the screen 28, the arrow joining the software image 38 and the software image 40 to each other. Thus, the setting unit 26 connects the application 1 and the application 2 to each other, and registers connection information indicating the connection relationship in the configuration management information in association with each of the application 1 and the application 2. The setting unit 26 connects the application 1 to the application 2 as the configuration of the data input destination (transmission destination). In addition, the setting unit 26 connects the application 2 to the application 1 as the configuration that inputs (transmits) data to the application 2. The connection information that is associated with the application 1 includes the software identification information indicating the application 2, which is the configuration of the connection partner and the configuration of the data input destination (transmission destination). The connection information that is associated with the application 2 includes the software identification information indicating the application 1, which is the configuration of the connection partner and the configuration that inputs (transmits) data to the application 2. By referring to the connection information that is associated with the application 1, the data input destination is identified as the application 2. By referring to the connection information that is associated with the application 2, the configuration that inputs data to the application 2 is identified as the application 1. During the execution of the collaborative function, data is input (transmitted) from the application 1 to the application 2.

In addition, the application 1 is connected to, in addition to the application 2, the application 3 as the configuration of the data input destination. Accordingly, the connection information that is associated with the application 1 includes the software identification information indicating the application 3, which is the configuration of the data input destination.

In addition, the application 2 is connected to, in addition to the application 1, the application 4 as the configuration of the data input destination. Accordingly, the connection information that is associated with the application 2 includes the software identification information indicating the application 1, which is the configuration that inputs data to the application 2, and the software identification information indicating the application 4, which is the configuration of the data input destination.

In addition, the application 3 is connected to the application 1 as the configuration that inputs data to the application 3, the application 4 as the configuration of the data input destination, and the robot B as the data input destination. Accordingly, the connection information that is associated with the application 3 includes the software identification information indicating the application 1, which is the configuration that inputs data to the application 3, the software identification information indicating the application 4, which is the configuration of the data input destination, and the device identification information indicating the robot B, which is the configuration of the data input destination.

The same applies to the other configurations. The connection information that is associated with the output configuration includes the configuration identification information indicating the input configuration that inputs data to the output configuration. For example, the connection information that is associated with the multi-function device A includes the software identification information indicating the application 4 and the device identification information indicating the robot B.

In the example illustrated in FIG. 3, the software image 38 and the software image 40 are joined to each other, and the software image 40 and the software image 44 are joined to each other. In addition, the software image 42 is joined to the software image 44 and the device image 46, and the software image 44 is joined to the software images 48 and 50 and the device image 52. Furthermore, the device image 46 and the device image 52 are joined to each other. That is, the application 1 is connected to each of the applications 2 and 3, the application 2 and the application 4 are connected to each other, the application 3 and the application 4 are connected to each other, and the application 3 and the robot B are connected to each other. In addition, the application 4 is connected to the applications 5 and 6 and the multi-function device A. The robot B and the multi-function device A are connected to each other.

If the configuration images are arranged in at least one input display region and in the output display region 36 and are joined to each other by a user operation and an instruction for setting the collaborative function is given by a user, the setting unit 26 associates the roles with the configurations and registers the configurations in the configuration management information. In addition, the setting unit 26 registers, in the function management information, the combination of the configurations that are associated with the configuration images joined to each other and the collaborative function that is designated as a function to be executed by the multiple configurations.

In the example illustrated in FIG. 3, the setting unit 26 registers, in the function management information, the combination of the applications 1, 2, 4, and 5 and the collaborative function that is designated as a function to be executed by the applications 1, 2, 4, and 5. The registered details also include information indicating the processes (input processes and output process) to be executed by the applications 1, 2, 4, and 5. Note that if data is input (transmitted) from the application 3 to the application 4, the applications 1, 2, 3, 4, and 5 may be registered as a group to be used for the collaborative function. The same applies to the other configurations. That is, the combination of the applications 1, 2, 4, and 6, the combination of the applications 1, 2, and 4 and the multi-function device A, the combination of the applications 1, 3, 4, and 5, the combination of the applications 1, 3, 4, and 6, the combination of the applications 1, 3, and 4 and the multi-function device A, and the combination of the applications 1 and 3, the robot B, and the multi-function device A are registered together with the collaborative functions to be executed by the respective combinations in the function management information. Note that, depending on the setting of the data input destination (transmission destination), the group of the applications 1, 2, 3, 4, and 6, the group of the applications 1, 2, 3, and 4, the robot B, and the multi-function device A, or the like may be registered as a group to be used for the collaborative function.

Now, a process flow during the execution of the collaborative function will be described.

For example, as long as the execution of the collaborative function that is registered is set to an active (on) state, the collaborative function is executed if the condition is satisfied. As long as the execution of the collaborative function is set to an off state, the collaborative function is not executed even if the condition is satisfied. The on/off state of the execution is set by a user, for example. It is needless to say that the collaborative function may be executed every time the condition is satisfied, without setting the on/off state.

For example, as long as the execution of the collaborative function is set to the active (on) state, if the first input condition that is associated with the application 1 is satisfied, the application 1 as the first input configuration executes the first input process that is associated with the application 1. The application 1 is connected to the applications 2 and 3 each as the second input configuration. Accordingly, the application 1 inputs (transmits) data (e.g., data generated through a process executed by the application 1, data used for the process, or data collected by the application 1) to the applications 2 and 3. Thus, if the configuration image that is associated with the input configuration is joined to the multiple configuration images, data is input (transmitted) to the multiple configurations. The same applies in the following description.

It the second input condition that is associated with the application 2 is satisfied, the application 2 as the second input configuration executes the second input process that is associated with the application 2. For example, the second input condition is the input of data from the application 1 to the application 2. The application 2 is connected to the application 4 as the third input configuration. Accordingly, the application 2 inputs (transmits) data (e.g., data generated through a process executed by the application 2, data used for the process, or data collected by the application 2) to the application 4.

If the second input condition that is associated with the application 3 is satisfied, the application 3 as the second input configuration executes the second input process that is associated with the application 3. For example, the second input condition is the input of data from the application 1 to the application 3. The application 3 is connected to the application 4 and the robot B each as the third input configuration. Accordingly, the application 3 inputs (transmits) data (e.g., data generated through a process executed by the application 3, data used for the process, or data collected by the application 3) to the application 4 and the robot B.

If the third input condition that is associated with the application 4 is satisfied, the application 4 as the third input configuration executes the third input process that is associated with the application 4. For example, the third input condition is the input of data from at least one of the applications 2 and 3 to the application 4. The application 4 is connected to the applications 5 and 6 and the multi-function device A each as the output configuration. Accordingly, the application 4 inputs (transmits) data (e.g., data generated through a process executed by the application 4, data used for the process, or data collected by the application 4) to the applications 5 and 6 and the multi-function device A.

If the third input condition that is associated with the robot B is satisfied, the robot B as the third input configuration executes the third input process that is associated with the robot B. For example, the third input condition is the input of data from the application 3 to the robot B. The robot B is connected to the multi-function device A as the output configuration. Accordingly, the robot B inputs (transmits) data (e.g., data generated through a process executed by the robot B, data used for the process, or data collected by the robot B) to the multi-function device A.

If the output condition that is associated with the application 5 is satisfied, the application 5 as the output configuration executes the output process that is associated with the application 5. For example, the output condition is the input of data from the application 4 to the application 5. The application 5 executes the final output process. This completes the collaborative function using the applications 1, 2, 4, and 5, the collaborative function using the applications 1, 3, 4, and 5, or the collaborative function using the applications 1, 2, 3, 4, and 5. These collaborative processes differ according to the data input (transmission) destination.

If the output condition that is associated with the application 6 is satisfied, the application 6 as the output configuration executes the output process that is associated with the application 6. For example, the output condition is the input of data from the application 4 to the application 6. The application 6 executes the final output process. This completes the collaborative function using the applications 1, 2, 4, and 6, the collaborative function using the applications 1, 3, 4, and 6, or the collaborative function using the applications 1, 2, 3, 4, and 6. These collaborative processes differ according to the data input (transmission) destination.

If the output condition that is associated with the multi-function device A is satisfied, the multi-function device A as the output configuration executes the output process that is associated with the multi-function device A. For example, the output condition is the input of data from at least one of the application 4 and the robot B to the multi-function device A. The multi-function device A executes the final output process. This completes the collaborative function using the applications 1, 2, and 4 and the multi-function device A, the collaborative function using the applications 1, 3, and 4 and the multi-function device A, the collaborative function using the applications 1, 2, 3, and 4 and the multi-function device A, the collaborative function using the applications 1 and 3, the robot B, and the multi-function device A, or the collaborative function using the applications 1, 2, 3, and 4, the robot B, and the multi-function device A.

Note that although the configuration images are displayed in all of the input display regions in the example illustrated in FIG. 3, the configuration images may be displayed in only a part of the input display regions. For example, if configuration images are displayed in both the first input display region 30 and the output display region 36 and are joined to each other, the setting unit 26 connects the first input configuration and the output configuration to each other. In this case, the first input configuration and the output configuration execute the collaborative function. In addition, a configuration image does not have to be displayed in a part of the input display regions. For example, configuration images may be displayed in the first input display region 30, the third input display region 34, and the output display region 36, and a configuration image does not have to be displayed in the second input display region 32. If the first input configuration is connected to the third input configuration, data is input from the first input configuration to the third input configuration.

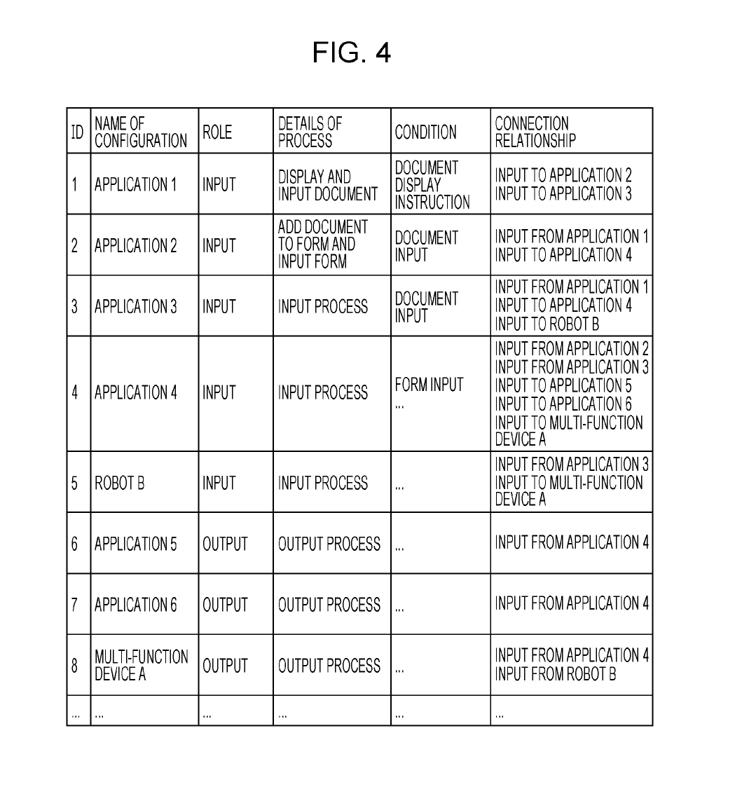

Now, a configuration management table as an example of the configuration management information will be described with reference to FIG. 4. The details of the configuration management table reflect the connection relationships of the respective configurations illustrated in FIG. 3.

The configuration management table includes, for example, the ID, information indicating the name of the configuration, information indicating the role that is associated with the configuration, information indicating the details of the process that is associated with the configuration, information indicating the condition for executing the process, the connection information (information indicating the connection relationship) indicating other configurations that are connected to the configuration, which are associated with each other.

For example, the first input process as the role is associated with the application 1. Specific details of the first input process are to display and input (transmit) document data to other configurations. The input condition is an instruction given to the application 1 for displaying a document. The application 1 is connected to the applications 2 and 3 as the configurations of the data input destinations. For example, if an instruction for displaying a document is given to the application 1 by a user, the application 1 displays and inputs the document data to the applications 2 and 3.

In addition, the second input process as the role is associated with the application 2. Specific details of the second input process are to add document data to form data and to input (transmit) the form data to other configurations. The input condition is the input of the document data to the application 2. The application 2 is connected to the application 1 as the configuration that inputs data to the application 2 and is connected to the application 4 as the configuration of the data input destination. For example, if the document data is input from the application 1 to the application 2, the application 2 adds the document data to form data and inputs the form data to the application 4.

Details that are substantially the same as the above details are registered in the configuration management table for the other configurations. Note that information indicating the relay apparatus 14 or relay software that manages or controls the devices 12 and the applications may be included in the connection information.

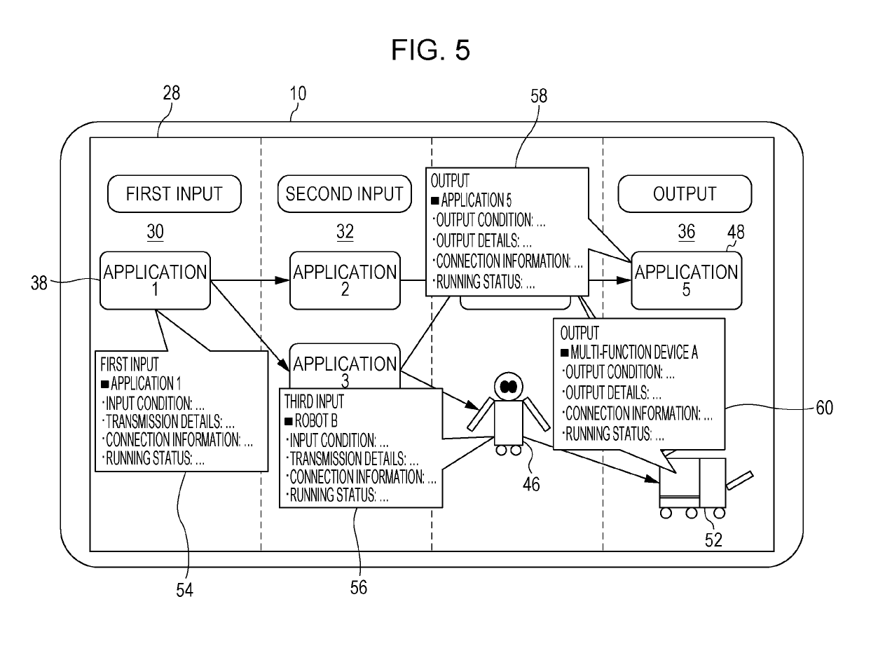

If a configuration image is designated by a user on the screen 28, the display control unit 24 may cause information to be displayed on the screen 28, and the information is, for example, the setting details of the configurations that are associated with the configuration image. This process will be described below in detail with reference to FIG. 5.

FIG. 5 illustrates the screen 28. For example, if a user designates the software image 38 (e.g., clicks the software image 38), the display control unit 24 causes a display region 54 such as a window, which is associated with the software image 38, to be displayed on the screen 28. In the display region 54, information indicating the input condition that is set for the application 1, information indicating transmission details, connection information, information indicating a running status, and the like are displayed. These information items are registered in the above configuration management table.

Examples of the information indicating transmission details include information indicating the details of the first input process that is associated with the application 1 and information indicating data to be input from the application 1 to the following configuration (e.g., the second input configuration). The data may be data generated through the first input process, data used for the first input process, or data collected by the application 1.

Since the application 1 is connected to the applications 2 and 3, as the connection information, the software identification information indicating the application 2 and the software identification information indicating the application 3 are displayed.

The information indicating the running status indicates the current running status or the running status of the past of the application 1. Examples of the running status include “processing”, “stopping”, “starting”, “out of service”, “maintenance”, “sleep mode”, and the like. For example, the control unit 22 acquires the information indicating the running status from the application 1. If the application 1 is installed in the terminal apparatus 10, the control unit 22 acquires the information indicating the running status from the terminal apparatus 10. If the application 1 is installed in another apparatus, the control unit 22 acquires the information indicating the running status from the other apparatus.

In addition, if the device image 46 is designated by a user, the display control unit 24 causes a display region 56 such as a window, which is associated with the device image 46, to be displayed on the screen 28. In the display region 56, information indicating the third input condition that is set for the robot B, information indicating the transmission details, the connection information, the information indicating the running status, and the like are displayed. The meaning of each information item is described above. Note that the control unit 22 acquires the information indicating the running status of the robot B from the robot B or an apparatus such as a relay apparatus that controls the robot B.

In addition, in the example illustrated in FIG. 5, the software image 48 is designated by a user, and a display region 58 for displaying the setting details of the application 5 is displayed. In addition, the device image 52 is designated by a user, and a display region 60 for displaying the setting details of the multi-function device A is displayed. Since the application 5 and the multi-function apparatus A are each the output configuration, information indicating the output condition and the output details is displayed as the setting details. The information indicating the output details includes information indicating the details of the output process and information indicating the result of the process.

A user may change the input condition, the output condition, the details of the input process, and the details of the output process. For example, if the input condition displayed in the display region 54 that is associated with the application 1 is changed by a user to another condition, the setting unit 26 registers the changed input condition as the condition that is associated with the application 1 in the configuration management table.

Now, the collaborative-function setting process will be described in more detail.

### Details of Collaborative-Function Setting Process

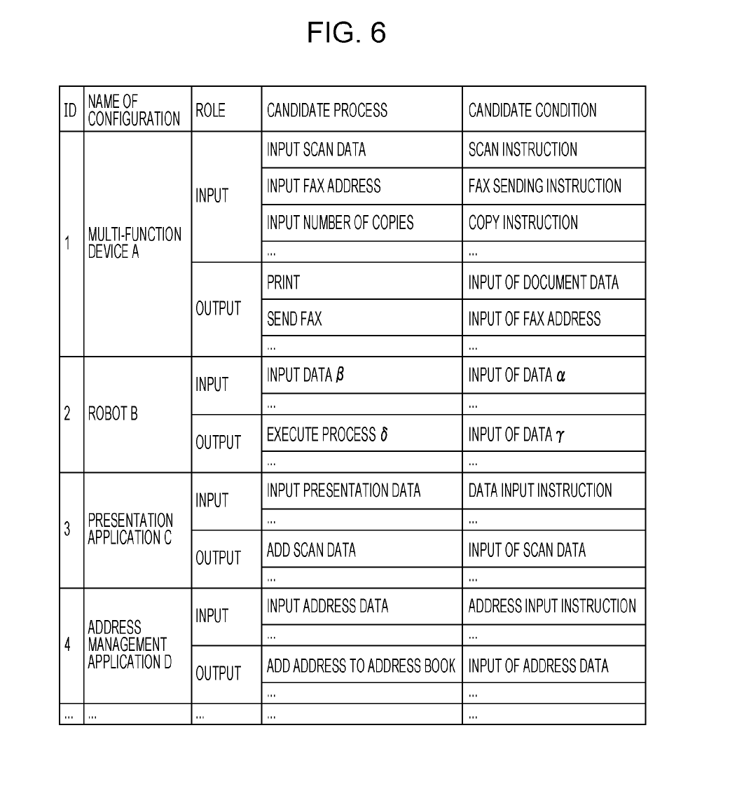

A candidate management table as an example of the candidate management information will be described with reference to FIG. 6. FIG. 6 illustrates an example of the candidate management table.

The candidate management table includes, for example, the ID, information indicating the name of the configuration, information indicating the role, information indicating candidate details of a process in accordance with the role, and information indicating candidate conditions for executing the process, which are associated with each other.

For example, “input (transmit) scan data”, “input (transmit) Fax address”, “input (transmit) number of copies”, and the like as candidate input processes are associated with the multi-function device A as a device 12. In addition, “scan instruction”, “Fax sending instruction”, “copy instruction”, and the like as candidate input conditions are associated with the multi-function device A.

The process of “input scan data” will be described. If a scan instruction is given to the multi-function device A, that is, if information indicating an instruction for executing scanning is input to the multi-function device A, the multi-function device A executes scanning and inputs (transmits) scan data generated through scanning to another configuration.

The process of “input Fax address” will be described. If a Fax sending instruction is given to the multi-function device A, that is, if information indicating an instruction for sending a Fax is input to the multi-function device A, the multi-function device A sends a Fax and inputs (transmits) data of the address to which the Fax is sent to the following configuration.

The process of “input number of copies” will be described. If a copy instruction is given to the multi-function device A, that is, if information indicating an instruction for executing copying is input to the multi-function device A, the multi-function device A executes copying and inputs (transmits) data of the number of copies to the following configuration.

For example, if a device image that is associated with the multi-function device A is displayed in an input display region, the display control unit 24 causes the display unit to display candidates for input operation (candidate input processes and candidate input conditions) that are associated with the multi-function device A.

In addition, “print”, “send Fax”, and the like as candidate output processes are associated with the multi-function device A. Furthermore, “input of document data”, “input of Fax address”, and the like as candidate output conditions are associated with the multi-function device A.

The process of “print” will be described. If document data is input to the multi-function device A, the multi-function device A prints the document data.

The process of “send Fax” will be described. If data of an address to which a Fax is to be sent is input to the multi-function device A, the multi-function device A sends the Fax to the address.

For example, if a device image that is associated with the multi-function device A is displayed in the output display region, the display control unit 24 causes the display unit to display candidates for output operation (candidate output processes and candidate output conditions) that are associated with the multi-function device A.

“Input data β” as a candidate input process is associated with the robot B as a device 12. In addition, “input of data α” as a candidate input condition is associated with the robot B. For example, if data α is input to the robot B, the robot B executes a specific process included in the input process and inputs (transmits) data β to the following configuration.

For example, if a device image that is associated with the robot B is displayed in an input display region, the display control unit 24 causes the display unit to display candidates for input operation (candidate input process and candidate input condition) that are associated with the robot B.

In addition, “execute process δ” as a candidate output process is associated with the robot B. Furthermore, “input of data γ” as a candidate output condition is associated with the robot B. For example, if data γ is input to the robot B, the robot B executes process δ.

For example, if a device image that is associated with the robot B is displayed in the output display region, the display control unit 24 causes the display unit to display candidates for output operation (candidate output process and candidate output condition) that are associated with the robot B.

“Input presentation data” as a candidate input process is associated with a presentation application C as software. In addition, “data input instruction” as a candidate input condition is associated with the presentation application C. For example, if a data input instruction is given to the presentation application C, the presentation application C inputs (transmits) presentation data to the following configuration.

For example, if a software image that is associated with the presentation application C is displayed in an input display region, the display control unit 24 causes the display unit to display candidates for input operation (candidate input process and candidate input condition) that are associated with the presentation application C.

In addition, “add scan data” as a candidate output process is associated with the presentation application C. Furthermore, “input of scan data” as a candidate output condition is associated with the presentation application C. For example, if scan data is input to the presentation application C, the presentation application C adds the scan data to the presentation data.

For example, if a software image that is associated with the presentation application C is displayed in the output display region, the display control unit 24 causes the display unit to display candidates for output operation (candidate output process and candidate output condition) that are associated with the presentation application C.

“Input address data” as a candidate input process is associated with an address management application D as software. In addition, “address input instruction” as a candidate input condition is associated with the address management application D. For example, if an address input instruction is given to the address management application D, the address management application D inputs (transmits) address data to the following configuration.

For example, if a software image that is associated with the address management application D is displayed in an input display region, the display control unit 24 causes the display unit to display candidates for input operation (candidate input process and candidate input condition) that are associated with the address management application D.

In addition, “add address to address book” as a candidate output process is associated with the address management application D. Furthermore, “input of address data” as a candidate output condition is associated with the address management application D. For example, if address data is input to the address management application D, the address management application D adds the address to address book data.

For example, if a software image that is associated with the address management application D is displayed in the output display region, the display control unit 24 causes the display unit to display candidates for output operation (candidate output process and candidate output condition) that are associated with the address management application D.

The order of priority may be set for the candidates. An example of the input processes and the input conditions of the multi-function device A will be described. For example, “input scan data” and “scan instruction” may have the first priority, “input Fax address” and “Fax sending instruction” may have the second priority, and “input number of copies” and “copy instruction” may have the third priority. In this case, the display control unit 24 causes the display unit to more preferentially display the candidates of the higher priority than the candidates of the lower priority. For example, the display control unit 24 may cause the display unit to display only the candidates of the first priority, may cause the display unit to display the candidates arranged in the order of priority from the top to the bottom, or may cause the display unit to display only the candidates of a predetermined priority or higher. The same applies to the other configurations as in the multi-function device A.

The details illustrated in FIG. 6 are merely examples, and candidate conditions and candidate processes are also associated with other configurations.

Now, the procedure for setting the collaborative function will be described in detail.

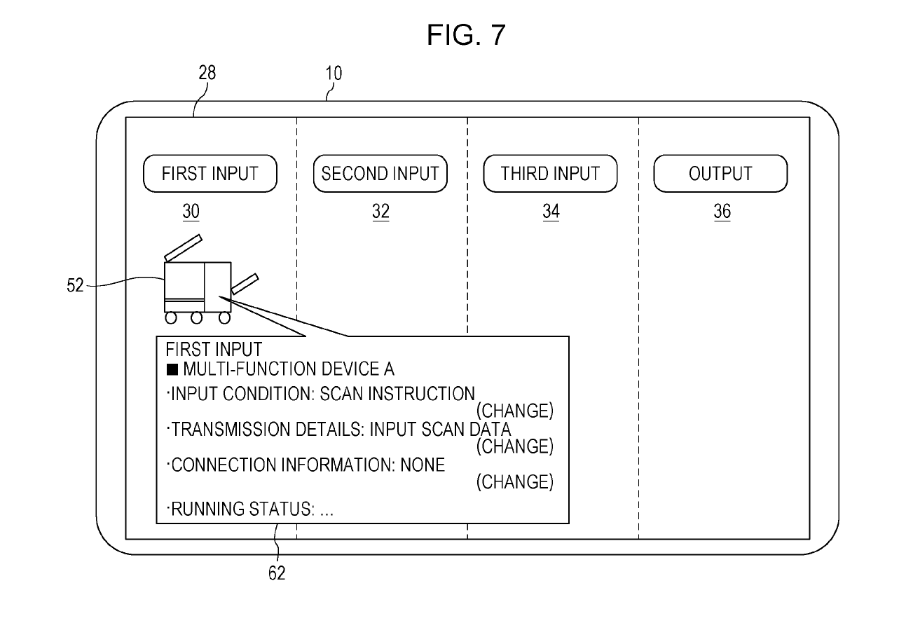

FIG. 7 illustrates the screen 28. For example, in accordance with a user's instruction, the device image 52 that is associated with the multi-function device A is displayed in the first input display region 30. Accordingly, the multi-function device A is used as the first input configuration. In addition, since the device image 52 is designated by a user on the screen 28, the display control unit 24 causes a display region 62 such as a window to be displayed on the screen 28 in association with the device image 52.

Since the device image 52 is displayed in the first input display region 30, the display control unit 24 causes the candidate input processes and the candidate input conditions to be displayed in the display region 62 more preferentially than the candidate output processes and the candidate output conditions. By referring to the above candidate management table, the display control unit 24 identifies the candidates (candidate input processes and candidate input conditions) that are associated with the multi-function device A and causes information indicating the candidates to be displayed in the display region 62.

For example, the display control unit 24 causes the candidate input processes and the candidate input conditions to be displayed in the display region 62 without causing the candidate output processes and the candidate output conditions to be displayed in the display region 62.

In addition, the display control unit 24 may cause the candidates to be displayed in the display region 62 in accordance with the order of priority. For example, the display control unit 24 causes only the candidates of the first priority to be displayed in the display region 62. It is assumed that “input (transmit) scan data” has the first priority as a candidate input process and that “scan instruction” has the first priority as a candidate input condition. In this case, the display control unit 24 causes information indicating “input (transmit) scan data” to be displayed as the candidate input process in the display region 62 and causes information indicating “scan instruction” to be displayed as the candidate input condition in the display region 62. In the example illustrated in FIG. 7, as the information indicating the transmission details, information indicating “input (transmit) scan data” as the candidate input process is displayed.

In addition, if a user presses a change button that is displayed in the display region 62, the display control unit 24 causes the following to be displayed on the screen 28: a list of candidate input conditions related to the multi-function device A and a list of candidate input processes (list of candidate transmission details) related to the multi-function device A. The candidates are, for example, the candidates registered in the above candidate management table.

Note that since the other configurations are not connected to the multi-function device A in the scene illustrated in FIG. 7, the connection information is not displayed. In addition, the information indicating the running status of the multi-function device A is displayed.

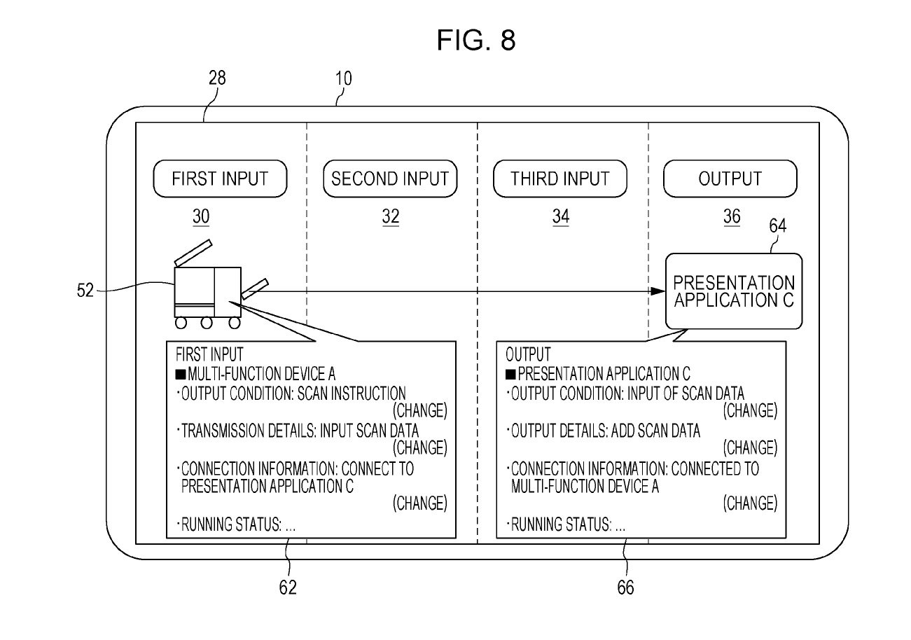

Now, operations after the device image 52 has been displayed in the first input display region 30 will be described with reference to FIG. 8. FIG. 8 illustrates the screen 28. For example, in accordance with a user's instruction, a software image 64 that is associated with the presentation application C is displayed in the output display region 36. Accordingly, the presentation application C is used as the output configuration.

Although the second input configuration and the third input configuration are not set in the example illustrated in FIG. 8, these configurations may alternatively be set.

Since the software image 64 is designated by a user on the screen 28, the display control unit 24 causes a display region 66 such as a window to be displayed on the screen 28 in association with the software image 64.

Since the software image 64 is displayed in the output display region 36, the display control unit 24 causes the candidate output processes and the candidate output conditions to be displayed in the display region 66 more preferentially than the candidate input processes and the candidate input conditions. By referring to the above candidate management table, the display control unit 24 identifies the candidates (candidate output processes and candidate output conditions) that are associated with the presentation application C and causes information indicating the candidates to be displayed in the display region 62.

For example, the display control unit 24 causes the candidate output processes and the candidate output conditions to be displayed in the display region 66 without causing the candidate input processes and the candidate input conditions to be displayed in the display region 66.

In addition, the display control unit 24 may cause the candidates to be displayed in the display region 66 in accordance with the order of priority. For example, the display control unit 24 causes only the candidates of the first priority to be displayed in the display region 66. It is assumed that “add scan data” has the first priority as a candidate output process and that “input of scan data” has the first priority as a candidate output condition. In this case, the display control unit 24 causes information indicating “add scan data” to be displayed as the candidate output process in the display region 66 and causes information indicating “input of scan data” to be displayed as the candidate output condition in the display region 66.

In addition, if a user presses a change button that is displayed in the display region 66, the display control unit 24 causes the following to be displayed on the screen 28: a list of candidate output conditions related to the presentation application C and a list of candidate output processes related to the presentation application C. The candidates are, for example, the candidates registered in the above candidate management table.

Furthermore, the device image 52 and the software image 64 are joined to each other. Thus, the multi-function device A and the presentation application C are connected to each other. Accordingly, in the display region 62 that is associated with the multi-function device A, information indicating the presentation application C that is connected to the multi-function device A is displayed as the connection information. Similarly, in the display region 66 that is associated with the presentation application C, information indicating the multi-function device A that is connected to the presentation application C is displayed as the connection information.

The setting unit 26 associates information indicating “input (transmit) scan data” as the input process, information indicating “scan instruction” as the input condition, and the connection information including software identification information indicating the “presentation application C” as the configuration of the input destination with the multi-function device A as the input configuration and registers the multi-function device A in the configuration management table.

Similarly, the setting unit 26 associates information indicating “add scan data” as the output process, information indicating “input of scan data” as the output condition, and the connection information including software identification information indicating the “multi-function device A” as the configuration that inputs data to the presentation application C with the presentation application C and registers the presentation application C in the configuration management table.

In addition, the setting unit 26 registers the collaborative function that is executed by using the multi-function device A and the presentation application C in the function management information. In this example, a function of “executing scanning by using the multi-function device A, inputting scan data from the multi-function device A to the presentation application C, and adding the scan data to presentation data by using the presentation application C” is registered as the collaborative function in the function management information.

Note that the display control unit 24 may cause the candidate output conditions and the candidate output processes on the assumption of the collaborative function to be displayed in the display region 66 more preferentially than the other conditions and processes. For example, by referring to the above candidate management table, the display control unit 24 causes a process to be preferentially displayed as the output process that is associated with the presentation application C, the process using data that is input from the multi-function device A to the presentation application C or a process whose condition is determined as the input of the data, and also causes the output condition for executing the output process to be preferentially displayed. For example, scan data is input from the multi-function device A to the presentation application C. In this case, the display control unit 24 causes a process to be preferentially displayed as the output process in a group of processes to be executed by the presentation application C, the process using the scan data or the process whose condition is determined as the input of the scan data. Since the process is “add scan data”, the display control unit 24 causes the process of “add scan data” to be preferentially displayed as the output process in the display region 66. Similarly, the display control unit 24 causes “input of scan data” to be preferentially displayed as the output condition in the display region 66. Thus, a user may easily select the output process that enables the collaborative function together with the input process by using the multi-function device A. In addition, even if the device 12 or the software as the output configuration has multiple functions, by preferentially displaying the candidate output processes and the candidate output conditions on the assumption of the collaborative function as described above, the numbers of choices of the output processes and the output conditions are decreased. Accordingly, compared with a case in which the candidates are displayed at random, a user may more easily select the output process and the output condition.

In a case in which the second input configuration and the third input configuration are set, the conditions and processes on the assumption of the collaborative function may also be preferentially displayed. For example, in a case in which the first input configuration is set and then a configuration image is displayed in the second input display region 32, the display control unit 24 may cause a process to be preferentially displayed as the second input process, the process using data that is input from the first input configuration to the second input configuration or a process whose condition is determined as the input of the data.

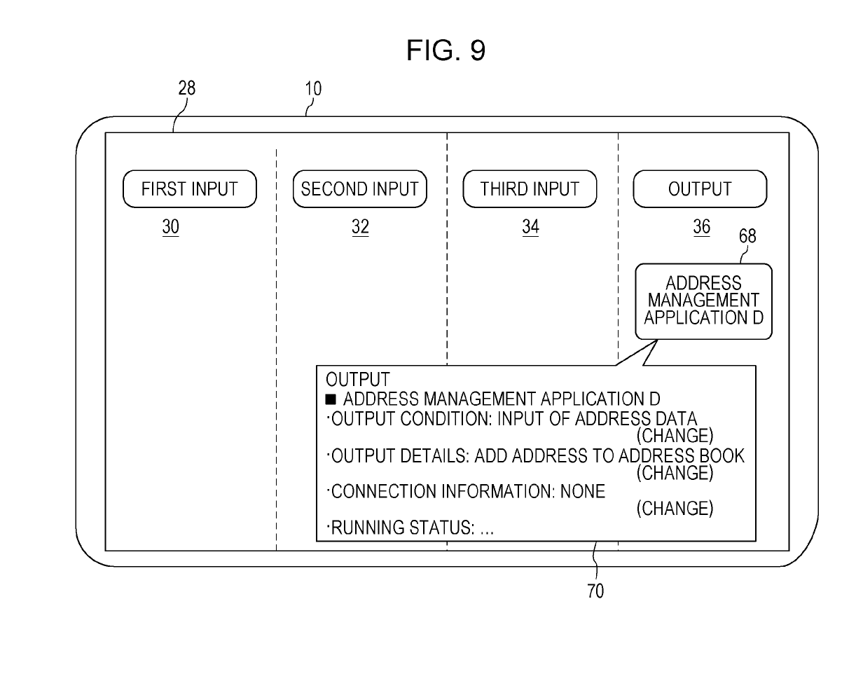

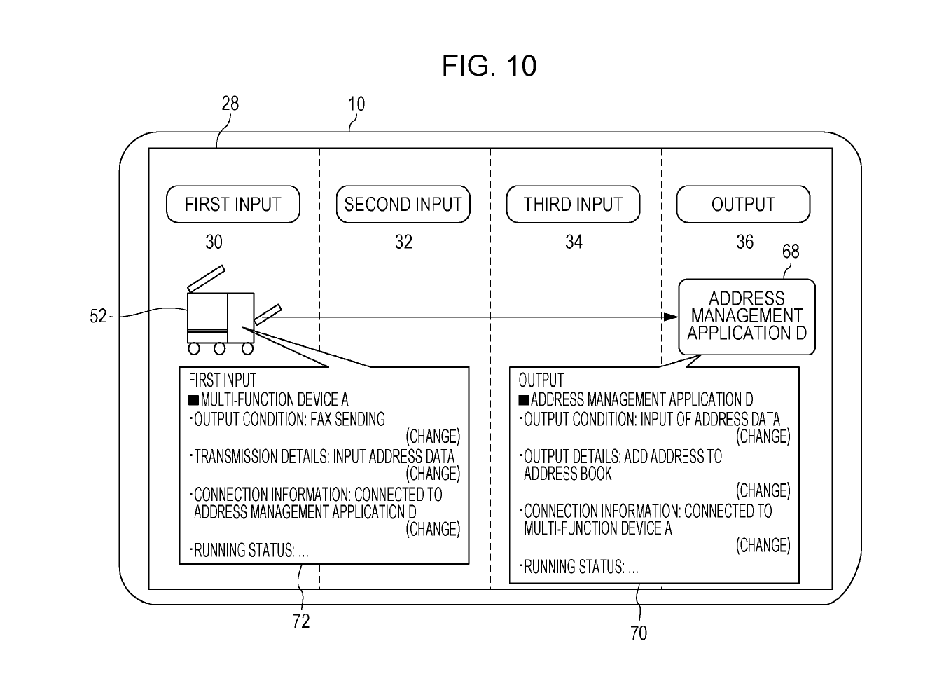

In the examples illustrated in FIG. 7 and FIG. 8, first, the input configuration is set, and then the output configuration is set. The setting may be performed in the reverse order. That is, first, the output configuration may be set, and then the input configuration may be set. This process will be described with reference to FIG. 9 and FIG. 10. FIG. 9 and FIG. 10 illustrate the screen 28.

For example, as illustrated in FIG. 9, in accordance with a user's instruction, a software image 68 that is associated with the address management application D is displayed in the output display region 36. Thus, the address management application D is used as the output configuration.

Since the software image 68 is designated by a user on the screen 28, the display control unit 24 causes a display region 70 such as a window to be displayed on the screen 28 in association with the software image 68.

Since the software image 68 is displayed in the output display region 36, the display control unit 24 causes the candidate output processes and the candidate output conditions to be displayed in the display region 70 more preferentially than the candidate input processes and the candidate input conditions. By referring to the above candidate management table, the display control unit 24 identifies the candidates (candidate output processes and candidate output conditions) that are associated with the address management application D and causes information indicating the candidates to be displayed in the display region 70.

In the example illustrated in FIG. 9, a user selects “input of address data” as the output condition and “add address to address book” as the output process.

Subsequently, as illustrated in FIG. 10, in accordance with a user's instruction, the device image 52 that is associated with the multi-function device A is displayed in the first input display region 30. If the device image 52 is designated by a user, a display region 72 that is associated with the device image 52 is displayed on the screen 28. Information indicating the setting details of the multi-function device A is displayed in the display region 72. For example, a user selects “send Fax” as the input condition and “input (transmit) address data” as the input process (transmission details).

In addition, the multi-function device A and the address management application D are connected to each other. Accordingly, information indicating the address management application D that is connected to the multi-function device A is displayed as the connection information in the display region 62 that is associated with the multi-function device A. Similarly, information indicating the multi-function device A that is connected to the address management application D is displayed as the connection information in the display region 70 that is associated with the address management application D.

The setting unit 26 associates information indicating “input (transmit) address data” as the input process, information indicating “send Fax” as the input condition, and the connection information including software identification information indicating the “address management application D” as the configuration of the input destination with the multi-function device A, and registers the multi-function device A as the input configuration in the configuration management table.

Similarly, the setting unit 26 associates information indicating “add address to address book” as the output process, information indicating “input of address data” as the output condition, and the connection information including device identification information indicating the “multi-function device A” as the configuration that inputs data to the address management application D with the address management application D, and registers the address management application D in the configuration management table.

In addition, the setting unit 26 registers the collaborative function to be executed by using the multi-function device A and the address management application D in the function management information. In this example, a function of “sending a Fax by using the multi-function device A, inputting, from the multi-function device A to the address management application D, data of the address to which the Fax is sent, and adding the address to the address book data by using the address management application D” is registered as the collaborative function in the function management information.

Note that the display control unit 24 may cause the candidate input conditions and the candidate input processes on the assumption of the collaborative function to be displayed in the display region 72 more preferentially than the other conditions and processes. For example, by referring to the above candidate management table, the display control unit 24 causes a process to be displayed preferentially as the input process that is associated with the multi-function device A, the process being a process for inputting data to be used by the address management application D to the address management application D or a process for inputting data corresponding to the output condition, and causes the input condition for executing the input process to be preferentially displayed. For example, the output condition that is set in the address management application D is “input of address data” and the output process is “add address to address book”. In this case, the display control unit 24 causes the following to be preferentially selected as the input process in a group of processes to be executed by the multi-function device A: a process for inputting address data to another configuration. Since this process is “input (transmit) address data”, the display control unit 24 causes the process of “input (transmit) address data” to be preferentially displayed as the input process in the display region 72. Similarly, the display control unit 24 causes “Fax sending” to be preferentially displayed as the input condition in the display region 72. Thus, a user may easily select the input process that enables the collaborative function together with the output process by using the address management application D. In addition, even if the device 12 or the software as the input configuration has multiple functions, by preferentially displaying the candidate input processes and the candidate input conditions on the assumption of the collaborative function as described above, the numbers of choices of the input processes and the input conditions are decreased. Accordingly, compared with a case in which the candidates are displayed at random, a user may more easily select the input process and the input condition.

Note that roles may be associated with the configurations in any order. For example, a user may firstly arrange a first configuration image in the second input display region 32, may secondly arrange a second configuration image in the output display region 36, and may thirdly arrange a third configuration image in the first input display region 30. By joining the third configuration image and the first configuration image to each other and by joining the first configuration image and the second configuration image to each other, the configurations are connected to each other.

As described above, according to this exemplary embodiment, through a simple operation of arranging configuration images in an input display region and the output display region and joining the configuration images to each other, the collaborative function may be set.

In addition, the processing details and conditions may be edited or checked, the connection relationship may be checked, and the running status may be checked, for example, on the screen for setting the collaborative function.

In addition, the display control unit 24 changes candidate processes to be associated with the configurations between when the roles are associated with the configurations in the order from the input process to the output process and when the roles are associated with the configurations in the order from the output process to the input process. For example, as illustrated in FIG. 7 and FIG. 8, if the first input process is set and then the output process is set, the display control unit 24 causes the display unit to display the candidate output processes and the candidate output conditions in accordance with the first input process and the first input condition. On the other hand, as illustrated in FIG. 9 and FIG. 10, if the output process is set and then the first input process is set, the display control unit 24 causes the display unit to display the candidate input processes and the candidate input conditions in accordance with the output process and the output condition. If the first input process is set first, since the output process is yet to be set, the display control unit 24 causes the display unit to display, for example, the candidate first input processes and the candidate first input conditions in the order of registration in the candidate management table (see FIG. 6) or at random. On the other hand, if the output process is set first, the display control unit 24 causes the display unit to display the candidate first input processes and the candidate first input conditions in accordance with the output process and the output condition. In the above manner, the candidate first input processes and the candidate first input conditions are changed between when the first input process is set first and when the first input process is set later. The same applies to a case in which the output process is set first, and since the first input process is yet to be set, the display control unit 24 causes the display unit to display, for example, the candidate output processes and the candidate output conditions in the order of registration in the candidate management table or at random. On the other hand, if the first input process is set first, the display control unit 24 causes the display unit to display the candidate output process and the candidate output conditions in accordance with the first input process and the first input condition. In the above manner, the candidate output processes and the candidate output conditions are changed between when the output process is set first and when the output process is set later. Through the above process, by changing the candidate processes and the candidate conditions, a user may easily select the input process or the output process that enables the collaborative function together with the input process or the output process that has already been set.

In addition, as described above, since the candidate processes and the candidate conditions are changed between when the roles are associated with the configurations in the order from the input process to the output process and when the roles are associated with the configurations in the order from the output process to the input process, the collaborative function to be displayed or set is changed. That is, the scenario for setting the collaborative function is changed. If the roles are associated with the configurations in the order from the first input process to the output process, the following input process and output process using the data to be input from the first input configuration are set. On the other hand, if the roles are associated with the configurations in the order from the output process to the first input process, the input process for inputting the data to be used for the output process is set. In this manner, the setting of the processes and conditions is changed depending on the order of association of the roles, and as a result, the collaborative function to be displayed or set is also changed.

Note that, when both the association of at least one input process and the association of the output process are completed, the setting unit 26 may complete the setting of the collaborative function and may register the collaborative function in the function management information. That is, if the input process is associated with at least one configuration but the output process is not associated with the configuration, the setting unit 26 does not register the input process that has been set at this stage in the collaborative function. Thus, the collaborative function that does not include the output process is prevented from being registered. Similarly, if the output process is associated with a configuration but the input process is not associated with the configuration, the setting unit 26 does not register the output process that has been set at this stage in the collaborative function. Thus, the collaborative function that does not include the input process is prevented form being registered.

Now, modifications of this exemplary embodiment will be described.

### First Modification

A first modification will be described. In the first modification, the roles are associated with the configurations without using the input display regions and the output display region. For example, when a configuration image is designated by a user, a display region for setting the role is displayed, and the role is associated in this display region.

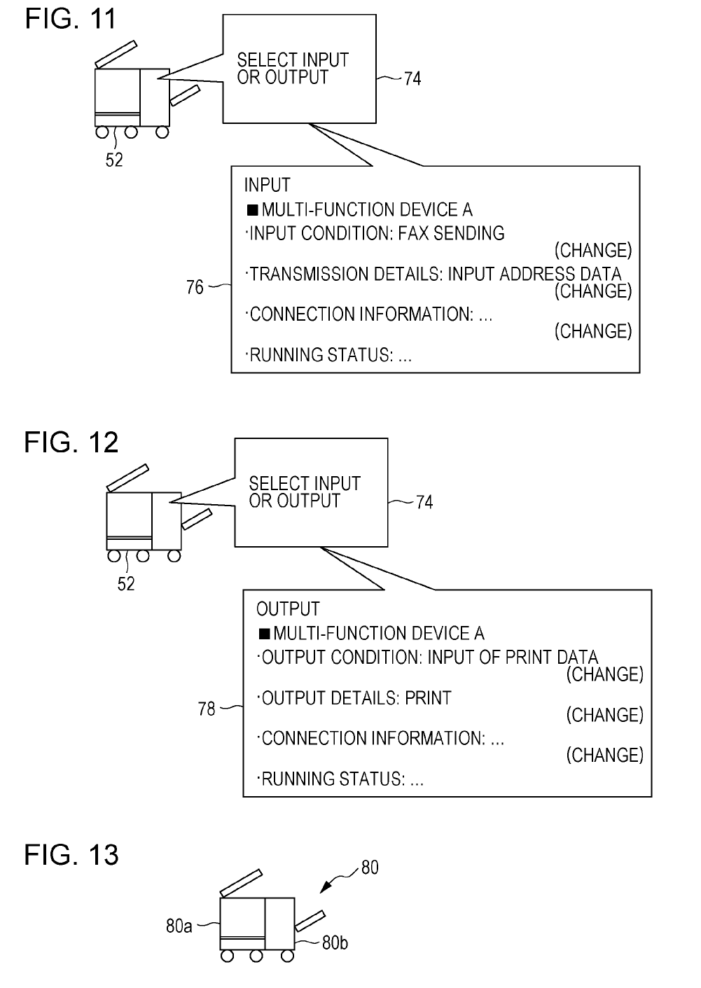

The first modification will be described below in detail with reference to FIG. 11 and FIG. 12. FIG. 11 and FIG. 12 illustrate the device image 52 as an example of the configuration image. The device image 52 is associated with the multi-function-device A. For example, if a user designates the device image 52 (e.g., clicks the device image 52) in a state in which the display unit displays the device image 52, as illustrated in FIG. 11, the display control unit 24 causes the display unit to display a display region 74 for selecting the role. In the display region 74, information indicating the input configuration and information indicating the output configuration are displayed.

If a user selects the input configuration (e.g., clicks the character string of “input”) in the display region 74, as illustrated in FIG. 11, the display control unit 24 causes the display unit to display a display region 76 for setting the input configuration. If a user selects the output configuration (e.g., clicks the character string of “output”) in the display region 74, as illustrated in FIG. 12, the display control unit 24 causes the display unit to display a display region 78 for selecting the output configuration.

In the display region 76 illustrated in FIG. 11, information indicating the input condition, information indicating the input process (transmission details), connection information, and information indicating a running status are displayed. As in the above-described exemplary embodiment, a user selects the input condition and the input process. A user also designates the configuration to which the multi-function device A is connected, and information indicating the configuration is displayed as the connection information.

In the display region 78 illustrated in FIG. 12, information indicating the output condition, information indicating the details of the output process, connection information, and information indicating a running status are displayed. As in the above-described exemplary embodiment, a user selects the output condition and the output process. A user also selects the configuration to which the multi-function device A is connected, and information indicating the configuration is displayed as the connection information.

As for a software image that is associated with software, a role is also associated with the software through the same or substantially the same operation as the above operation.

According to the first modification, even in a case in which the input display regions and the output display region are not used, the collaborative function may be set by associating the role with each configuration through a simple operation.

### Second Modification

A second modification will be described. In the second modification, a role is associated with a part of a device 12, and a collaborative function that is executable by using the part is set.

The part of the device 12 will be described below with reference to FIG. 13. FIG. 13 illustrates a multi-function device 80 as an example of the device 12. For example, the multi-function device 80 includes a main part 80a and a post-processing unit 80b. The main part 80a has, for example, a print function, a scan function, and a copy function. The post-processing unit 80b has, for example, a post-processing function such as a staple function. In this manner, different functions may be assigned to the parts of the device 12. As another example, a communication function, a data storing function, and the like are assigned to a main part of a PC, and a display function is assigned to a display unit of the PC.

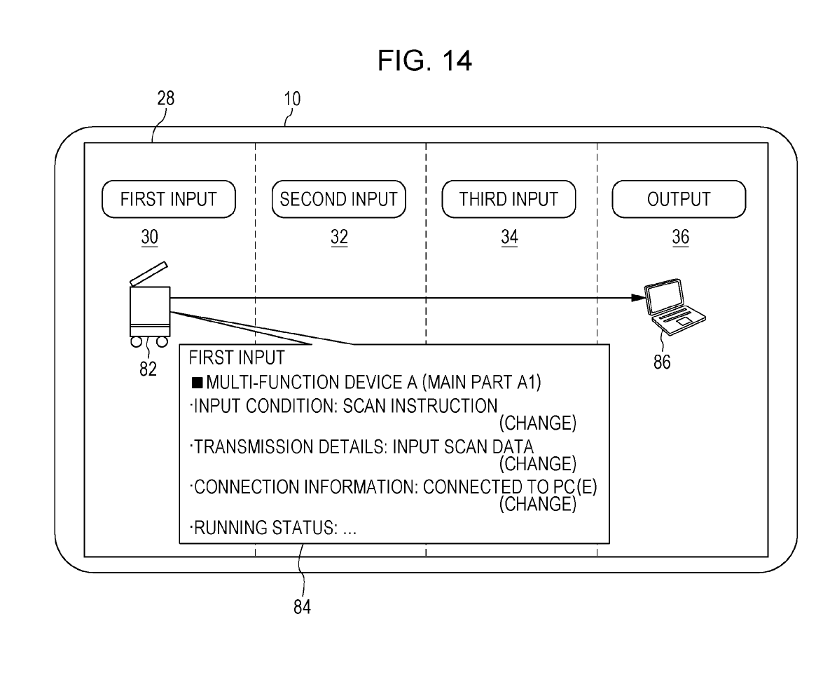

A process according to the second modification will be described below with reference to FIG. 14. FIG. 14 illustrates the screen 28. For example, in accordance with a user's instruction, a device image 82 (partial image) that is associated with a main part A1 of the multi-function device A is displayed in the first input display region 30. If the device image 82 is designated by a user, the display control unit 24 causes a display region 84 such as a window to be displayed on the screen 28 in association with the device image 82. The setting details of the main part A1 are displayed in the display region 84. As in the above-described exemplary embodiment, information indicating the input condition, information indicating the details of the input process (transmission details), connection information, and information indicating a running status are displayed. As an example, a user selects “scan instruction” as the input condition and “input (transmit) scan data” as the input process (transmission details).

In addition, in accordance with a user's instruction, a device image 86 that is associated with a PC (E) is displayed in the output display region 36. As in the above-described exemplary embodiment, the output condition and the output process are set for the PC (E). For example, “input of scan data” is set as the output condition, and “store scan data” is set as the output process.

In addition, the device images 82 and 86 are joined to each other, and thus, the main part A1 and the PC (E) are connected to each other. Information indicating the PC (E) is displayed as the connection information in the display region 84.

The setting unit 26 associates information indicating “input (transmit) scan data” as the input process, information indicating “scan instruction” as the input condition, and connection information including device identification information indicating the PC (E) as the configuration of the input destination with the main part A1 of the multi-function device A and registers the main part A1 as the input configuration in the configuration management table.

Similarly, the setting unit 26 associates information indicating “store scan data” as the output process, information indicating “input of scan data” as the output condition, and connection information including device identification information indicating “main part A1 of multi-function device A” as the configuration that inputs data to the PC (E) in association with the PC (E) and registers the PC (E) in the configuration management table.

In addition, the setting unit 26 registers the collaborative function to be executed by using the main part A1 of the multi-function device A and the PC (E) in the function management information. In this example, a function of “executing scanning by using the main part A1 of the multi-function device A, inputting scan data from the main part A1 to the PC (E), and storing the scan data in the PC (E)” is registered as the collaborative function in the function management information.

According to the second modification, the collaborative function that is executable by using the part of the device 12 may be set.

Note that the output configuration may be set first also in a case in which the part of the device 12 is used. In addition, in a case in which software has multiple functions, at least one of the multiple functions may be used as a part of software. In this case, a role may be associated with the part of software (at least one function).

### Third Modification

A third modification will be described. In the third modification, if a role is associated with a configuration, the display control unit 24 introduces another candidate configuration that is assumed to execute a collaborative function together with the configuration. The third modification will be described below in detail.

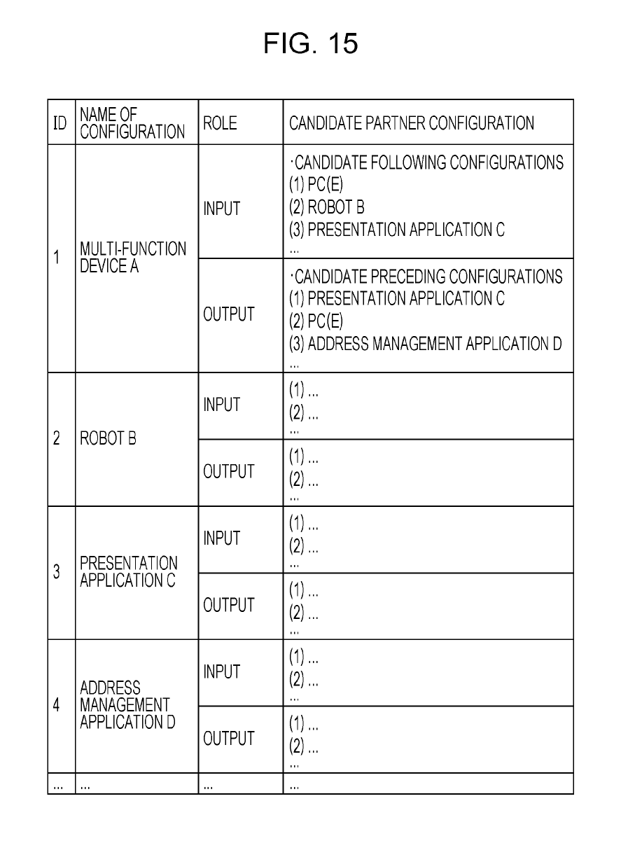

FIG. 15 illustrates an example of a compatibility management table. The compatibility management table is for managing the compatibility between configurations. The compatibility management table includes, as an example, the ID, information indicating the name of the configuration, information indicating the role, and information indicating the candidate partner configuration, which are associated with each other. The partner configuration is a configuration that is assumed to be connected to the configuration that is associated with the role and to execute the collaborative function together with the configuration. One or more partner configurations are registered in the compatibility management table for each configuration. In addition, the order of priority is associated with each partner configuration. For example, a higher priority is associated with a partner configuration having a higher possibility to be connected to the configuration that is associated with the role and to be used for the collaborative function together with the configuration. For example, on the basis of the history of connection between the configurations, the use history of the collaborative function, the use history of each configuration, the compatibility between the functions, and the like, the possibility is determined in advance, and the order of priority is determined.

For example, as candidate configurations connected to the multi-function device A as a following configuration, the PC (E), the robot B, the presentation application C, and the like are associated with the multi-function device A as the input configuration. For example, the PC (E) has the first priority, the robot B has the second priority, and the presentation application C has the third priority. Note that the following configuration connected to the multi-function device A may be the input configuration or the output configuration.

In addition, as candidate configurations (input configurations) connected to the multi-function device A as a preceding configuration, the presentation application C, the PC (E), the address management application D, and the like are associated with the multi-function device A as the output configuration. For example, the presentation application C has the first priority, the PC (E) has the second priority, and the address management application D has the third priority.

Candidate partner configurations are associated with the other configurations, as in the multi-function device A.

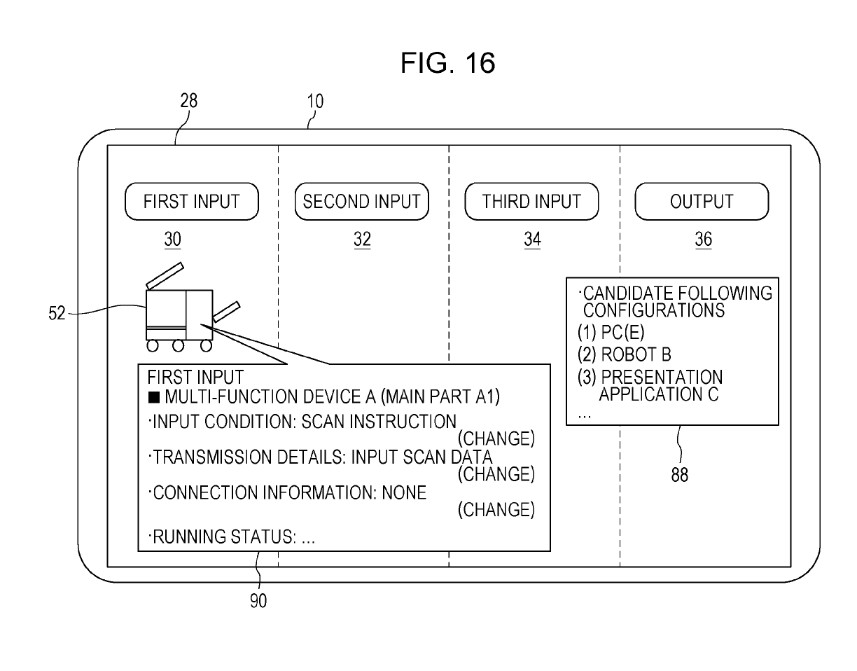

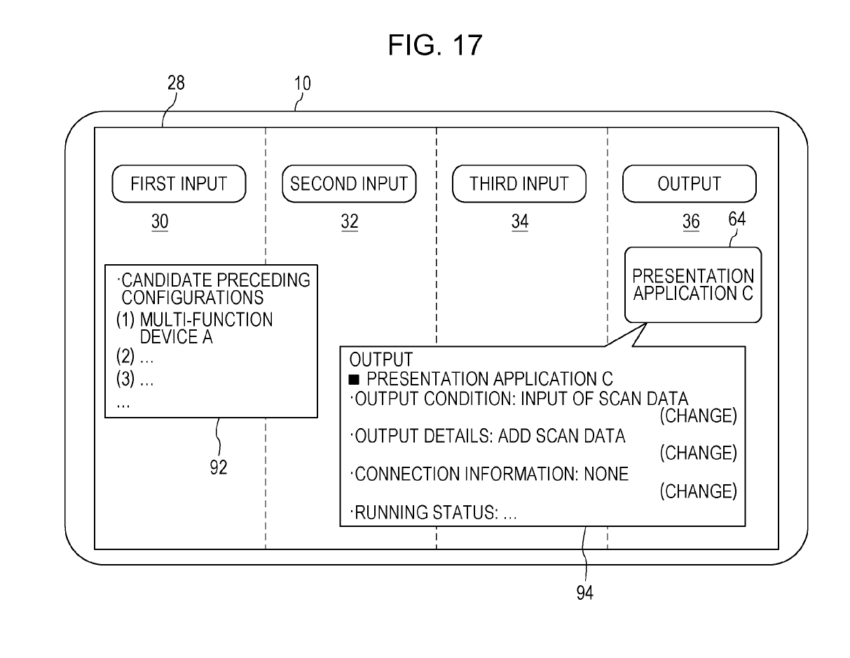

The process according to the third modification will be described below in detail with reference to FIG. 16 and FIG. 17. FIG. 16 and FIG. 17 illustrate the screen 28.

As illustrated in FIG. 16, for example, the device image 52 that is associated with the multi-function device A is displayed in the first input display region 30. In this case, the multi-function device A corresponds to the input configuration. In the compatibility management table, the display control unit 24 identifies the partner configurations that are associated with the multi-function device A as the input configurations, and causes information indicating the partner configurations to be displayed on the screen 28. For example, the display control unit 24 causes a display region 88 such as a window to be displayed on the screen 28. In the display region 88, information indicating the partner configurations that are associated with the multi-function device A as the input configurations is displayed. For example, the PC (E) is displayed as a first partner configuration, the robot B is displayed as a second partner configuration, and the presentation application C is displayed as a third partner configuration.

On the screen 28, the display control unit 24 causes the display region 88 to be displayed at a position designated by a user. If a user selects a configuration from the group of configurations displayed in the display region 88, the display control unit 24 causes a configuration image that is associated with the configuration to be displayed in an input display region or the output display region where the display region 88 is displayed. For example, if the configuration is selected by a user in a state in which the display region 88 is displayed in the output display region 36, the display control unit 24 causes the configuration image that is associated with the configuration to be displayed in the output display region 36. Thus, the setting unit 26 registers the configuration as the output configuration. If the configuration is selected in a state in which the display region 88 is displayed in the second input display region 32, the configuration is registered as the second input configuration. Similarly, if the configuration is selected in a state in which the display region 88 is displayed in the third input display region 34, the configuration is registered as the third input configuration. It is needless to say that a configuration that is not displayed in the display region 88 may be selected by a user, and a role may be associated with the configuration.

In addition, as in the above-described exemplary embodiment, if the device image 52 is designated by a user, the display control unit 24 causes a display region 90 indicating the setting details of the multi-function device A to be displayed on the screen 28. The display control unit 24 may cause configurations that use data to be input from the multi-function device A or configurations whose condition is determined as the input of the data to be displayed as candidate following configurations on the screen 28. For example, since scan data is input from the multi-function device A to other configurations, the display control unit 24 causes configurations that use the scan data to be displayed as the candidate following configurations on the screen 28.

FIG. 17 illustrates another example. For example, the software image 64 that is associated with the presentation application C is displayed in the output display region 36. In this case, the presentation application C corresponds to the output configuration. In the compatibility management table, the display control unit 24 identifies partner configurations that are associated with the presentation application C as the output configurations, and causes information indicating the partner configurations to be displayed on the screen 28. For example, the display control unit 24 causes a display region 92 such as a window to be displayed on the screen 28. In the display region 92, information indicating the partner configurations that are associated with the presentation application C as the output configurations is displayed. For example, the multi-function device A is displayed as a first partner configuration, and the other configurations are displayed as a second and the following partner configurations. As described above with reference to FIG. 16, if a configuration is selected by a user from the group of configurations displayed in the display region 92, the display control unit 24 causes a configuration image that is associated with the configuration to be displayed in an input display region or the output display region where the display region 92 is displayed. For example, if a configuration is selected by a user in a state in which the display region 92 is displayed in the first input display region 30, the display control unit 24 causes the configuration image that is associated with the configuration to be displayed in the first input display region 30. Thus, the setting unit 26 registers the configuration as the first input configuration. Similarly, if the display region 92 is displayed in any other input display region, similar operations are performed. It is needless to say that a configuration that is not displayed in the display region 92 may be selected by a user, and a role may be associated with the configuration.

In addition, as in the above-described exemplary embodiment, if the software image 64 is designated by a user, the display control unit 24 causes a display region 94 indicating the setting details of the presentation application C to be displayed on the screen 28. The display control unit 24 may cause the following configurations to be displayed as candidate preceding configurations on the screen 28: a configuration that inputs data to be used by the presentation application C and a configuration that inputs data corresponding to the output condition. For example, since the output condition of the presentation application C is the input of scan data, the display control unit 24 causes a configuration that inputs the scan data to another configuration (e.g., the multi-function device A) to be displayed on the screen 28 as a candidate preceding configuration.

### Fourth Modification

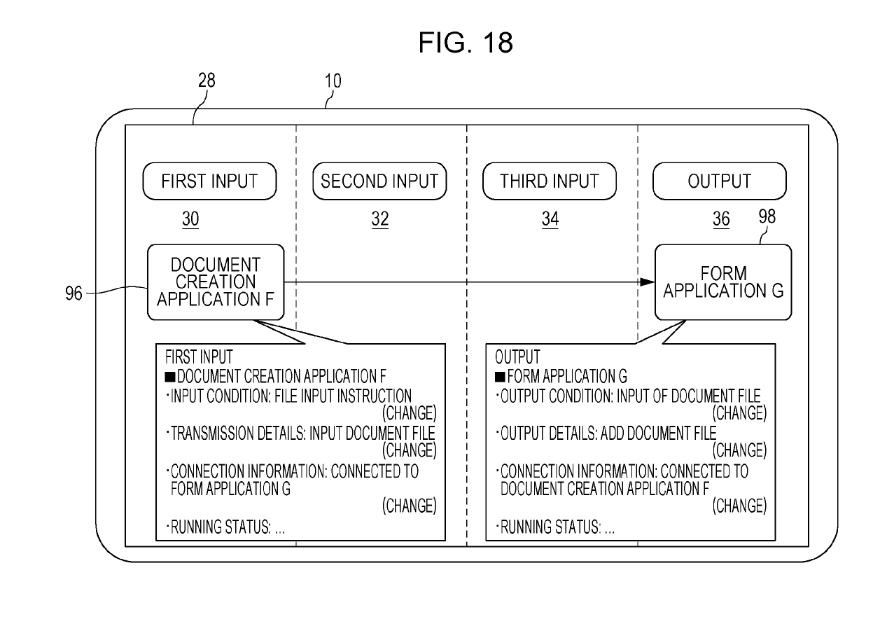

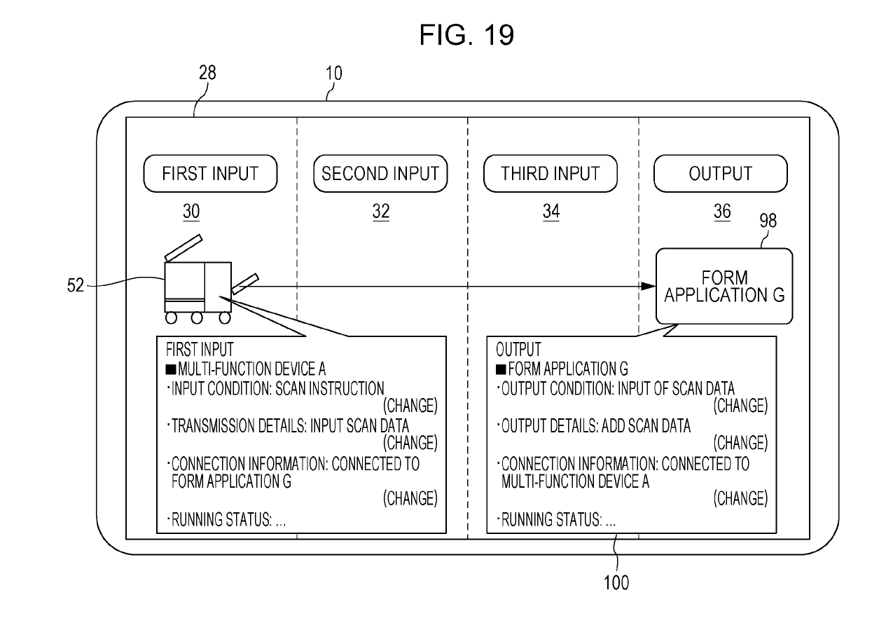

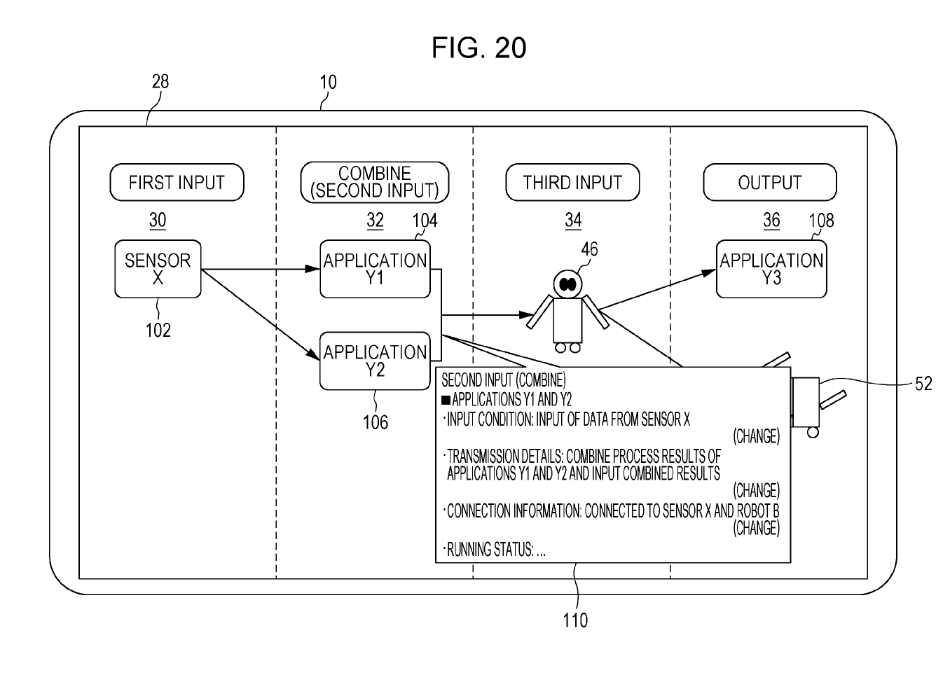

A fourth modification will be described. In the fourth modification example, if a configuration or a process is changed, the display control unit 24 changes candidate processes or conditions of another configuration that is connected to the configuration. The fourth modification example will be described below in detail with reference to FIG. 18 and FIG. 19. FIG. 18 and FIG. 19 illustrate the screen 28.

For example, as illustrated in FIG. 18, a software image 96 that is associated with a document creation application F as software is displayed in the first input display region 30. In addition, a software image 98 that is associated with a form application G as software is displayed in the output display region 36. The document creation application F and the form application G are connected to each other.

The first input process as the role is associated with the document creation application F. The details of the first input process are to input a document file to another configuration. The first input condition is a file input instruction.

The output process as the role is associated with the form application G. The details of the output process are to add a document file to a form file. The output condition is the input of the document file to the form application G.

A collaborative function to be executed by using the document creation application F and the form application G is a function of “inputting the document file from the document creation application F to the form application G and adding the document file to the form file by using the form application G.

If an instruction for setting the collaborative function is given by a user, as in the above-described exemplary embodiment, the setting unit 26 associates information indicating the first input process, information indicating the first input condition, and connection information with the document creation application F and registers the document creation application F in the configuration management table. Similarly, the setting unit 26 associates information indicating the output process, information indicating the output condition, and connection information with the form application G and registers the form application G in the configuration management table. In addition, the setting unit 26 registers the collaborative function to be executed by using the document creation application F and the form application G in the function management information.

Furthermore, as illustrated in FIG. 19, it is assumed that the first input configuration is changed by a user from the document creation application F to another configuration, the multi-function device A. The multi-function device A is connected to the form application G. In addition, a user designates “scan instruction” as the first input condition and “input (transmit) scan data” as the first input process (transmission details).

In this case, the display control unit 24 changes and displays the configuration in the setting details of the output configuration that is connected to the first input configuration. For example, in accordance with the details of the first input process, the display control unit 24 changes and displays candidate setting details of the output configuration. Specifically, the display control unit 24 causes the following processes to be displayed as the candidate output processes in a display region 100 that is associated with the software image 98: a process that uses data to be input from the first input configuration to the output configuration and a process whose output condition is determined as the input of the data from the first input configuration. In the example illustrated in FIG. 19, data to be input from the multi-function device A to the form application G is changed to scan data. Accordingly, the display control unit 24 causes “add scan data”, which is a process using the scan data, to be displayed as a candidate output process in the display region 100. That is, the details of the output process are changed from “add document file” to “add scan data”. In addition, the display control unit 24 causes “input of scan data” to be displayed as a candidate output condition in the display region 100.

A collaborative function to be executed by using the multi-function device A and the form application G is a function of “executing scanning by using the multi-function device A, inputting scan data from the multi-function device A to the form application G, and adding the scan data to the form file by using the form application G”.

If an instruction for setting the collaborative function is given by a user, the setting unit 26 associates information indicating the first input process, information indicating the first input condition, and connection information with the multi-function device A and registers the multi-function device A in the configuration management table. Similarly, the setting unit 26 associates information indicating the output process, information indicating the output condition, and connection information with the form application G and registers the form application G in the configuration management table. In addition, the setting unit 26 registers the collaborative function to be executed by using the multi-function device A and the form application G in the function management information.

Note that in a case in which the original setting details are registered, the setting unit 26 may delete the original setting details. For example, the setting unit 26 may delete, from the configuration management table, management table, the information indicating the first input process, the information indicating the first input condition, and the connection information that are associated with the document creation application F. In addition, the setting unit 26 may delete the registration of the document creation application F from the configuration management table. Furthermore, the setting unit 26 may delete the collaborative function to be executed by using the document creation application F and the form application G from the function management information.

Although the configuration is changed in the above example, if the process details that are set for the configuration are changed, the processes and conditions that are associated with the other configurations may be changed in accordance with the change. For example, although the document creation application F is selected as the first input configuration, if the details of the first input process are changed to other details, the display control unit 24 may change and display the output process and the output condition that are associated with the form application G in accordance with the change.

According to the fourth modification, if a configuration or process is changed, the candidate processes or candidate conditions for another configuration that is connected to the configuration are changed and displayed in accordance with the change. Thus, a user may easily select a process that is suitable for the changed configuration.

### Other Exemplary Embodiments

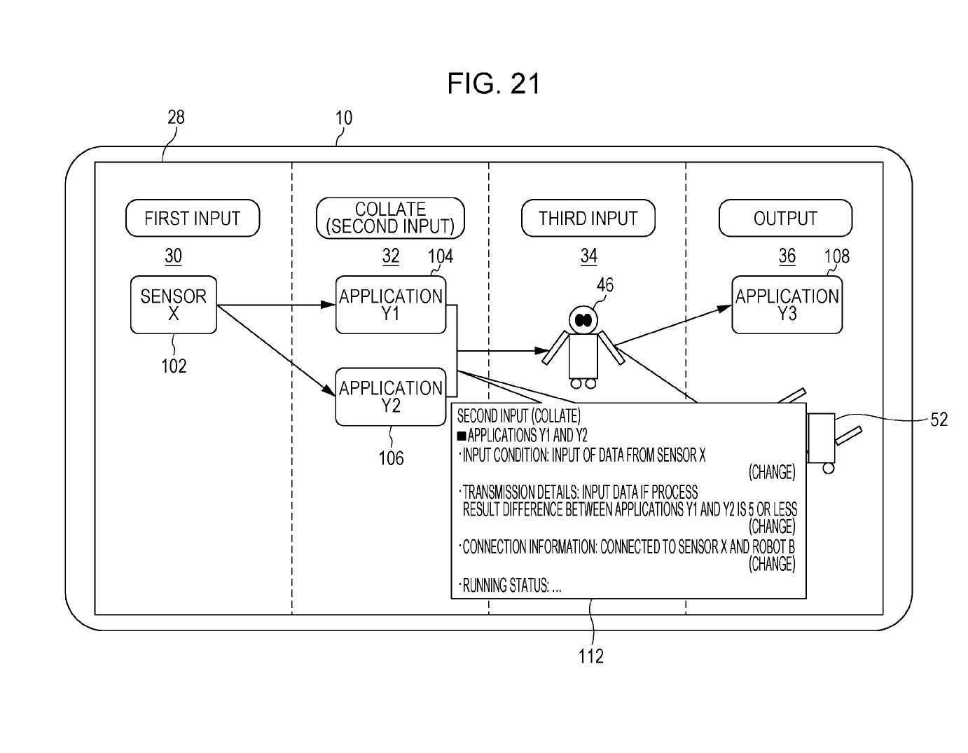

Now, various exemplary embodiments other than the above-described exemplary embodiments will be described with reference to FIG. 20 and FIG. 21. FIG. 20 illustrates an example of a collaborative function including a combining process. FIG. 21 illustrates an example of a collaborative function including a collating process. In the following description, first, the collaborative function including the combining process will be described with reference to FIG. 20, and then, the collaborative function including the collating process will be described with reference to FIG.

21.

FIG. 20 illustrates the screen 28. For example, the combining process as the role is associated with the second input display region 32. Accordingly, if a configuration image is displayed in the second input display region 32, the combining process is executed on data from a configuration that is associated with the configuration image.

In the first input display region 30, a device image 102 that is associated with a sensor X as a device 12 is displayed. Accordingly, the sensor X is used as the first input configuration.

In the second input display region 32, a software image 104 that is associated with an application Y1 as software and a software image 106 that is associated with an application Y2 as software are displayed. Accordingly, the applications Y1 and Y2 are each used as the second input configuration. In addition, since the combining process is associated with the second input display region 32, data from the application Y1 and data from the application Y2 are combined.

In the third input display region 34, the device image 46 that is associated with the robot B as a device 12 is displayed. Accordingly, the robot B is used as the third input configuration.

In the output display region 36, a software image 108 that is associated with an application Y3 as software and the device image 52 that is associated with the multi-function device A as a device 12 are displayed. Accordingly, the application Y3 and the multi-function device A are each used as the output configuration.

In addition, the sensor X is connected to each of the applications Y1 and Y2. Each of the applications Y1 and Y2 is connected to the robot B. The robot B is connected to each of the application Y3 and the multi-function device A.

The sensor X is, for example, a temperature sensor, an infrared sensor, or the like, and inputs data representing a detection result or a measurement result to the applications Y1 and Y2.

In response to the input of data from the sensor X, the applications Y1 and Y2 execute processes that are associated with the applications Y1 and Y2. Since the combination process is associated with the applications Y1 and Y2, the data from the application Y1 and the data from the application Y2 are combined, and data representing the combination result (hereinafter referred to as “combined data”) is input to the robot B. For example, addition, multiplication, or the like of data is executed as the combining process. The data from the application Y1 is data generated by the execution of the application Y1, data collected by the application Y1, or the like. The data from the application Y2 is data generated by the execution of the application Y2, data collected by the application Y2, or the like.

The data combination may be executed by, for example, the control unit 22, at least one of the applications Y1 and Y2, or another device 12 or another application (e.g., a device 12 or an application having a function of combining data).

Upon reception of the combined data from the second input configuration, the robot B executes the process that is associated with the robot B and inputs data to the application Y3 and the multi-function device A. The application Y3 and the multi-function device A perform output processes that are associated with the application Y3 and the multi-function device A.

In addition, in FIG. 20, a display region 110 indicating the setting details of the applications Y1 and Y2 is displayed on the screen 28. For example, if a user designates the second input display region 32, at least one of the software images 104 and 106, or an arrow that joins the software images 104 and 106 to the device image 46, the display control unit 24 causes the display region 110 to be displayed on the screen 28. In the display region 110, the input condition, the transmission details, the connection information, and the running status that are associated with the applications Y1 and Y2 are displayed. The input condition includes a condition for executing the combining process.

Three or more data items may alternatively be combined. For example, if a software image that is associated with the application Y4 is displayed in the second input display region 32, data from the application Y1, data from the application Y2, and data from the application Y4 are combined, and the combined data is input to the robot B.

Although data items from multiple pieces of software are combined in the example illustrated in FIG. 20, data items from multiple devices 12 may be combined, or data from one or more pieces of software and data from one or more devices 12 may be combined.

In addition, in the example illustrated in FIG. 20, if the software images 104 and 106 are displayed in the second input display region 32 with which the combining process is associated, the combining process is associated with the applications Y1 and Y2. However, the combining process may be associated with the configurations by another method. For example, as illustrated in FIG. 20, if a line that joins the software image 104 and the device image 46 to each other and a line that joins the software image 106 and the device image 46 to each other are combined (merged) at the middle, the combining process may be associated with the applications Y1 and Y2. For example, a user operates and combines the two lines on the screen 28. In this case, the combining process does not have to be associated with a configuration that is associated with a configuration image that is not combined with a line. Specifically, even if a software image that is associated with the application Y4 is displayed in the second input display region 32, as long as a line that joins the software image and another configuration image to each other is not combined with another line, data from the application Y4 is not combined with data from another configuration but is input to the following configuration.

In addition, the combining process may be associated with an input display region other than the second input display region 32 and the output display region. The combining process may be associated with multiple input display regions and both an input display region and the output region. For example, the combining process is associated with an input display region and the output display region that is designated by a user. In the example illustrated in FIG. 20, if the combining process is associated with the output display region 36, data from the application Y3 and data from the multi-function device A are combined.

As described above, the collaborative function including the combining process as the role may be set through a simple operation.

The collaborative function including the collating process will be described below with reference to FIG. 21. FIG. 21 illustrates the screen 28. For example, the collating process as the role is associated with the second input display region 32. Accordingly, if a configuration image is displayed in the second input display region 32, the collating process is executed on data from a configuration that is associated with the configuration image. The configuration images are arranged in the same manner as that illustrated in FIG. 20.

Since the collating process is associated with the second input display region 32, data from the application Y1 and data from the application Y2 are collated with each other. For example, a data difference process or the like is executed as the collating process. For example, a difference between the data from the application Y1 and the data from the application Y2 is calculated. If the difference falls within a predetermined allowable range (e.g., if the difference is less than or equal to 5), the collated data is input to the robot B. The collated data is, for example, data representing the difference, data representing that the difference falls within the allowable range, or the like. The unit of a numeric value representing the allowable range is determined in accordance with the type of data that is the target of the collating process. For example, if the data that is the target of the collating process is temperature data, the unit of temperature is used as the unit of the numeric value representing the allowable range. Other physical quantity, calculated value, or the like may alternatively be used as the numeric value representing the allowable range.

The data collation may be executed by, for example, the control unit 22, at least one of the applications Y1 and Y2, or another device 12 or another application (e.g., a device 12 or an application having a data collating function).

Upon reception of the collated data from the second input configuration, the robot B executes the process that is associated with the robot B and inputs data to the application Y3 and the multi-function device A. The application Y3 and the multi-function device A execute output processes that are associated with the application Y3 and the multi-function device A.

In addition, in FIG. 21, a display region 112 indicating the setting details of the applications Y1 and Y2 is displayed on the screen 28. For example, if a user designates the second input display region 32, at least one of the software images 104 and 106, or an arrow that joins the software images 104 and 106 to the device image 46, the display control unit 24 causes the display region 112 to be displayed on the screen 28. In the display region 112, the input condition, the transmission details, the connection information, and the running status that are associated with the applications Y1 and Y2 are displayed. The input condition includes a condition for executing the collating process.

Three or more data items may alternatively be collated. For example, if a software image that is associated with the application Y4 is displayed in the second input display region 32, data from the application Y1, data from the application Y2, and data from the application Y4 are collated. For example, a difference between two data items among the three data items is calculated, and the difference is calculated for combinations of all of the data items. For example, if all of the differences fall within the allowable range, the collated data is input to the robot B.

Although data items from multiple pieces of software are collated in the example illustrated in FIG. 21, data items from multiple devices 12 may be collated, or data from one or more pieces of software and data from one or more devices 12 may be collated.

In addition, as in the combining process, by combining (merging) lines, the collating process may be associated with a configuration. In this case, the collating process does not have to be associated with a configuration that is associated with a configuration image that is not combined with a line.

Furthermore, the collating process may be associated with an input display region other than the second input display region 32 or the output display region. The collating process may also be associated with multiple input display regions or both the input display region and the output display region. For example, the collating process is associated with an input display region designated by a user and the output display region. In the example illustrated in FIG. 21, if the collating process is associated with the output display region 36, the data from the application Y3 and the data from the multi-function device A are collated.

As described above, the collaborative function including the collating process as the role may be set through a simple operation.

The collaborative function including various processes in combination other than the above examples may be set. For example, an extracting process, the combining process, and the collating process may be executed in combination. In this manner, by executing various processes in combination, various collaborative functions may be set and executed.

### Function Management Table

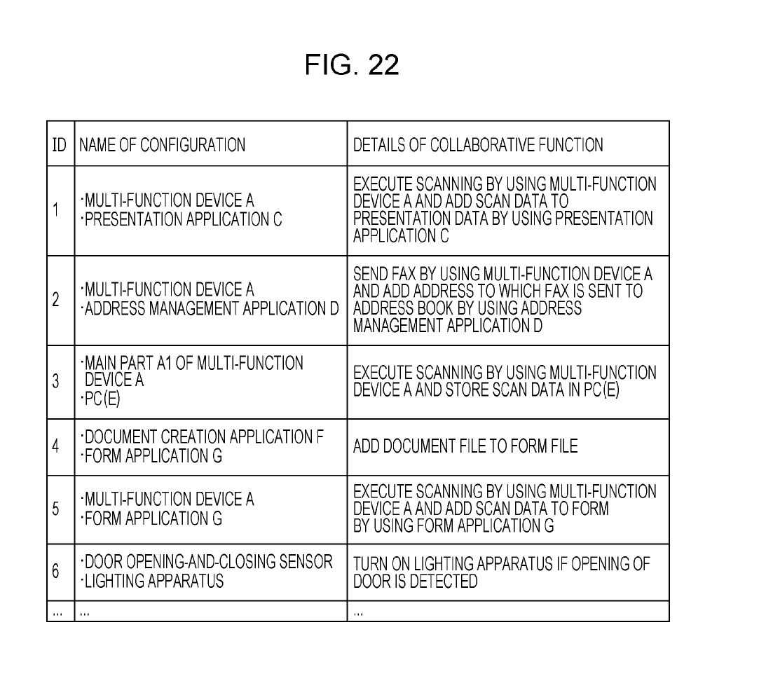

Now, a function management table as an example of the function management information will be described with reference to FIG. 22. FIG. 22 illustrates an example of the function management table. The function management table includes, as an example, the ID, information indicating the name of the configuration that is used for the collaborative function, and information indicating the details of the collaborative function, which are associated with each other.

The collaborative function of the ID “1” is executable by using the multi-function device A as the input configuration and the presentation application C as the output configuration.

The collaborative function of the ID “2” is executable by using the multi-function device A as the input configuration and the address management application D as the output configuration.

The collaborative function of the ID “3” is executable by using the main part A1 of the multi-function device A as the input configuration and the PC (E) as the output configuration.

The collaborative function of the ID “4” is executable by using the document creation application F as the input configuration and the form application G as the output configuration.

The collaborative function of the ID “5” is executable by using the multi-function device A as the input configuration and the form application G as the output configuration.

The collaborative functions of the IDs “1” to “5” are described in the above exemplary embodiment and modifications.

The collaborative function of the ID “6” is executable by using a door opening-and-closing sensor as the input configuration and a lighting apparatus as the output configuration. This collaborative function turns on the lighting apparatus in response to detection of opening of the door by using the door opening-and-closing sensor.

The collaborative functions illustrated in FIG. 22 are merely examples, and other collaborative functions may be set.

The above-described terminal apparatus 10 is realized by, as an example, collaborative working of hardware and software. Specifically, the terminal apparatus 10 includes one or more processors such as a central processing unit (CPU) that is not illustrated. The one or more processors read and execute a program stored in a storage apparatus that are not illustrated, and thereby the function of each unit of the terminal apparatus 10 is realized. The program is stored in the storage apparatus via a recording medium such as a compact disc (CD) or a digital versatile disc (DVD) or via a communication path such as a network. As another example, each unit of the terminal apparatus 10 may be realized by a hardware resource such as a processor, an electronic circuit, or an application specific integrated circuit (ASIC). For this realization, a device such as a memory may also be used. As still another example, each unit of the terminal apparatus 10 may be realized by a digital signal processor (DSP), a field programmable gate array (FPGA), or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising:
a controller comprising a display control unit configured to cause a display to display various items for setting a collaborative function and a setting unit configured to set the collaborative function that is executable by using multiple configurations by associating an input process or an output process as a role,
wherein if the setting unit judges that the role represented by an image is associated with a configuration to be used for a collaborative function, the controller changes, in accordance with the role, the collaborative function to be set by using the image.

2. The information processing apparatus according to claim 1, wherein the controller associates the role with the image in accordance with a display position of the image.

3. The information processing apparatus according to claim 2, wherein, if the image is displayed in a display region with which the role is associated, the controller associates the role with the image.

4. The information processing apparatus according to claim 2, wherein the controller further controls display of a candidate process in accordance with the role.

5. The information processing apparatus according to claim 4, wherein the controller further controls display of a candidate condition for executing the process.

6. The information processing apparatus according to claim 4, wherein the controller further controls display of candidate data to be transmitted to another configuration.

7. The information processing apparatus according to claim 1, wherein, if the image is designated, the controller further controls display of another configuration connected to the configuration that is associated with the image.

8. The information processing apparatus according to claim 1, wherein, if the image is designated, the control unit further controls display of a running status of the configuration that is associated with the image.

9. The information processing apparatus according to claim 1, wherein the role includes a first role and a second role, the first role being a role of executing a first process of transmitting data to another configuration, the second role being a role of executing a second process of finally outputting the data.

10. The information processing apparatus according to claim 9, wherein the collaborative function includes both the first role and the second role.

11. The information processing apparatus according to claim 10, wherein, if association of the first role and the second role is completed, the controller completes a setting of the collaborative function.

12. The information processing apparatus according to claim 9, wherein the controller changes the collaborative function in accordance with an order of association of the first role and the second role.

13. The information processing apparatus according to claim 9, wherein the controller changes, in accordance with an order of association of the first role and the second role, candidate processes in accordance with the roles.

14. The information processing apparatus according to claim 9, wherein the controller sets a data transmission destination by an operation of joining the image that is associated with the configuration to another image that is associated with the other configuration.

15. The information processing apparatus according to claim 1, wherein the configuration is at least one of an apparatus and software.

16. A non-transitory computer readable medium storing a program causing a computer to execute a process for information processing, the process comprising:
using a controller to display various items for setting a collaborative function;
using the controller to set the collaborative function that is executable by using multiple configurations by associating an input process or an output process as a role;
if the role represented by an image that is associated with a configuration to be used for a collaborative function, using the controller to change, in accordance with the role, the collaborative function to be set by using the image.
